(19) United States
(12) Patent Application Publication
(10) Pub. No.: US 2014/0351563 A1
(43) Pub. Date: Nov. 27, 2014

(54) ADVANCED PROCESSOR ARCHITECTURE

(71) Applicant: HYPERION CORE INC., Los Gatos, CA (US)

(72) Inventor: Martin Vorbach, Lingenfeld (DE)

(73) Assignee: HYPERION CORE INC., Los Gatos, CA (US)

(21) Appl. No.: 14/365,617

(22) PCT Filed: Dec. 17, 2012
(86) PCT No.: PCT/IB2012/002997

§ 371 Date: Jun. 13, 2014

(30) Foreign Application Priority Data
Dec. 16, 2011 (EP) 11 009 911.6
Mar. 12, 2012 (EP) 12001692.8
Jun. 6, 2012 (EP) 12004331.0
Jun. 8, 2012 (EP) 12004345.0

(51) Int. Cl. G06F 9/30

(52) U.S. Cl. CPC G06F 9/3001; G06F 9/30098
USPC 712/221

(57) ABSTRACT

The present invention relates to a processor core having an execution unit comprising an arrangement of Arithmetic-Logic-Units, wherein the operation mode of the execution unit is switchable between an asynchronous operation of the Arithmetic-Logic-Units and interconnection between the Arithmetic-Logic-Units such that a signal. from the register file crosses the execution unit and is receipt by the register file in one clock cycle; and wherein a pipelined operation mode of at least one of the Arithmetic-Logic-Units and the interconnection between the Arithmetic-Logic-Units such that a signal requires from the register file through the execution unit back to the register file more than one clock cycles.

### PRIORITY

Priority is claimed to the patent applications [1], [2], [3], [4], [5] and [6].

### INTRODUCTION AND FIELD OF INVENTION

The present invention relates to data processing in general and to data processing architecture in particular.

Energy efficient, high speed data processing is desirable for any processing device. This holds for all devices wherein data are processed such as cell phones, cameras, hand held computers, laptops, workstations, servers and so forth offering different processing performance based on accordingly adapted architectures.

Often similar applications need to be executed on different devices and/or processor platforms. Since coding software is expensive, it is be desirable to have software code which can be compiled without major changes for a large number of different platforms offering different processing performance.

It would be desirable to provide a data processing architecture that can be easily adapted to different processing performance requirements while necessitating only minor adoptions to coded software

It is an object of the present invention to provide an improvement over the prior art of processing architectures with respect to at least one of data processing efficiency, power consumption and reuse of the software codes.

The present invention describes a new processor architecture called ZZYX thereafter, overcoming the limitations of both, sequential processors and dataflow architectures, such as reconfigurable computing.

It shall be noted that whereas hereinafter, frequently terms such as “each” or “every” and the like are used when certain preferred properties of elements of the architecture and so forth are described. This is done so in view of the fact that generally, it will be highly preferred to have certain advantageous properties for each and every element of a group of similar elements. It will be obvious to the average skilled person however, that some if not all of the advantages of the present invention disclosed hereinafter might be obtainable, even if only to a lesser degree, if only some but not all similar elements of a group do have a particular property. Thus, the use of certain words such as “each”, “any” “every” and so forth. is intended to disclose the preferred mode of invention and whereas it is considered feasible to limit any claim to only such preferred embodiments, it will be obvious that such limitations are not meant to restrict the scope of the disclosure to only the embodiments preferred. Subsequently Trace-Caches are used. Depending on their implementation, they either hold undecoded instructions or decoded instructions. Decoded instructions might be microcode according to the state of the art. Hereinafter the content of Trace-Caches is simply referred as instruction or opcodes. It shall be pointed out, that depending on the implementation of the Trace-Cache and/or the Instruction Decode (ID) stage, actually microcode might reside in the Trace-Cache. It will be obvious for one skilled in the art that this is solely implementation dependent; it is understood that “instructions” or “opcodes” in conjunction with Trace-Cache is understood as “instructions, opcodes and/or microcodes (depending on the embodiment)”.

It shall also be noted that notwithstanding the fact that a completely new architecture is disclosed hereinafter, several aspects of the disclosure are considered inventive per se, even in cases where other advantageous aspects described hereinafter are not realized.

The technology described in this patent is particularly applicable on
ZYXX processors as described in PCT/EP 2009/007415 and PCT/EP 2011/003428;
their memory architectures as described in PCT/EP 2010/003459, which are also applicable on multi-core processors are known in the state of the art (e.g. from Intel, AMD, MIPS and ARM); and
exemplary methods for operating ZYXX processors and the like as described in ZZYX09 (DE 10 013 932.8), PCT/EP 2010/007950.

The patents listed above are fully incorporated by reference for detailed disclosure.

The ZZYX processor comprises multiple ALU-Blocks in an array with pipeline stages between each row of ALU-Blocks. Each ALU-BLOCK may comprise further internal pipeline stages. In contrast to reconfigurable processors data flows preferably in one direction only, in the following exemplary embodiments from top to bottom. Each ALU may execute a different instruction on a different set of data, whereas the structure may be understood as a MIMD (Multiple Instruction, Multiple Data) machine.

The ZZYX processor is optimized for loop execution. In contrast to traditional processors, instructions once issued to the ALUs may stay the same for a plurality of clock cycles, while multiple data words are streamed through the ALUs. Each of the multiple data words is processed based on the same temporarily fixed instructions. After a plurality of clock cycles, e.g. when the loop has terminated, the operation continues with one or a set of newly fetched, decoded and issued instruction(s).

The ZZYX processor provides sequential VLIW-like processing combined with superior dataflow and data stream processing capabilities. The ZZYX processor cores are scalable in at least 3 ways:
1. The number of ALUs can be scaled at least two dimensionally according to the required processing performance; the term multi-dimensional is to refer to “more than one dimension”. It should be noted that stacking several planes will lead to a three dimensional arrangement;
2. the amount of Load/Store units and/or Local Memory Blocks is scalable according to the data bandwidth required by the application;
3. the number of ZZYX cores per chip is scalable at least one dimensionally, preferably two or more dimensionally, according to the product and market. Low cost and low power mobile products (such as mobile phones, PDAs, cameras, camcorders and mobile games) may comprise only one or a very small amount of ZZYX cores, while high end consumer products (such as Home PCs, HD Settop Boxes, Home Servers, and gaming consoles) may have tens of ZZYX cores or more.
   High end applications, such as HPC (high performance computing) systems, accelerators, servers, network infrastructure and high and graphics may comprise a very large number of interconnected ZZYX cores.

ZZYX processors may therefore represent one kind of multicore processor and/or chip multiprocessors (CMPs) architecture.

The major benefit of the ZZYX processor concept is the implicit software scalability. Software written for a specific ZZYX processor will run on single processor as well as on a multi processor or multicore processor arrangement without modification as will be obvious from the text following hereinafter. Thus, the software scales automatically according to the processor platform it is executed on.

The concepts of the ZZYX processor and the inventions described in this patent are applicable on traditional processors, multithreaded processors and/or multi-core processors. A traditional processor is understood as any kind of processor, which may be a microprocessor, such as e.g. an AMD Phenom, Intel i7, i5, Pentium, Core2 or Xeon, IBM's and Sony's CELL processor, ARM, Tensilica or ARC; but also DSPs such as e.g. the C64 family from TI, 3DSP, Starcore, or the Blackfin from Analog Devices.

The concepts disclosed are also applicable on reconfigurable processors, such as SiliconHive, IMEC's ADRES, the DRP from NEC, Stretch, or IPFlex; or multi-processors systems such as Picochip or Tilera. Most of the concepts, especially the memory hierarchy, local memories elements, and Instruction Fetch units as well as the basic processor model can be used in FPGAs, either by configuring the according mechanisms into the FPGAs or by implementing according hardwired elements fixedly into the silicon chip. FPGAs are known as Field Programmable Gate Arrays, well known from various suppliers such as XILINX (e.g. the Virtex or Spartan families), Altera, or Lattice.

The concepts disclosed are particularly well applicable on stream processors, graphics processors (GPU) as for example known from NVidia (e.g. GeForce, and especially the CUDA technology), ATI/AMD and Intel (e.g. Larrabee), and especially General Purpose Graphics Processors (GPGPU) also know from NVidia, ATI/AMD and Intel.

ZZYX processors may operate stand alone, or integrated partially, or as a core into traditional processors or FPGAs (such as e.g. Xilinx Virtex, Spartan, Artix, Kintex, ZYNQ; or e.g. Altera Stratix, Arria, Cyclone). While ZZYX may operate as a co-processor or thread resource connected to a processor (which may be a microprocessor or DSP), it may be integrated into FPGAs as processing device. FPGAs may integrate just one ZZYX core or multiple ZZYX cores arranged in a horizontal or vertical strip or as a multi-dimensional matrix.

All described embodiments are exemplary and solely for the purpose of outlining the inventive apparatuses- and/or methods. Different aspects of the invention can be implemented or combined in various ways and/or within or together with a variety of other apparatuses and/or methods.

A variety of embodiments is disclosed in this patent. However, it shall be noted, that the specific constellation of methods and features depends on the final implementation and the target specification. For example may a classic CISC processor require another set of features than a CISC processor with a RISC core, which again differs from a pure RISC processor, which differs from a VLIW processor. Certainly, a completely new processor architecture, not bound to any legacy, may have another constellation of the disclosed features. On that basis it shall be expressively noted, that the methods and features which may be exemplary combined for specific purposes may be mixed and claimed in various combinations for a specific target processor.

### Architecture Basics

In one classification algorithms could be divided into 2 classes. A first class formed by control intense code comprising sparse loops, instructions are seldom repeated. The second class contains all data intense code, comprising many loops repeating instructions, which is often operating on blocks or streams of data.

The first class of algorithms seldom benefits from pipelining. A rather small register file (8-16 registers) is sufficient for most of the algorithms. Compare, logical functions, simple arithmetic such as addition and subtraction, and jumps are the most common instructions. Conditional code appears frequently. Low latency, e.g. for memory load instructions, is crucial.

The second class of algorithms frequently benefits from pipelining, simultaneously latency, e.g. for memory load instructions, is mostly no critical performance factor. Typically a large amount of registers (32 to a few hundred) are beneficial. Complex arithmetic instructions are commonly used, e.g. multiplication, power, (square) root, sin, cos, etc., while jumps and conditional execution appears more seldom.

Obviously the two algorithm classes would benefit from rather contrary processor architectures. The inventive architecture is based on the ZZYX processor model (e.g. [1], [2], [3], [4], [5]; all previous patents of the assignee are incorporated by reference) and provides optimal, performance and power efficient support for both algorithm classes, by switching the execution mode of the processor.

Switching the execution mode may comprise, but is not limited to the one or more of the following exemplary items:

| Algorithm Class 1 | Algorithm Class 2 |
|---|---|
| Load memory data to | Load memory data directly |
| register file. | to execution units |
| Execution units operate | Execution units operate |
| on register file | on data directly received |
| | from load/store units |
| Execution units operate | Execution units operate |
| non-pipelined | pipelined |
| Execution units are | Execution units are |
| asynchronously chained, | synchronously chained, |
| with no pipeline stage in | one or more pipeline |
| between | stages are located between |
| | chained execution units |
| Low clock frequency | High clock frequency |
| allowing asynchronous | supported by pipelining |
| execution | |

The low clock frequency used for executing algorithms class 1 enables low power dissipation, while the asynchronous chaining of execution units (e.g. ALUs within the ALU-Block (AB)) supports a significant amount of instruction level parallelism.

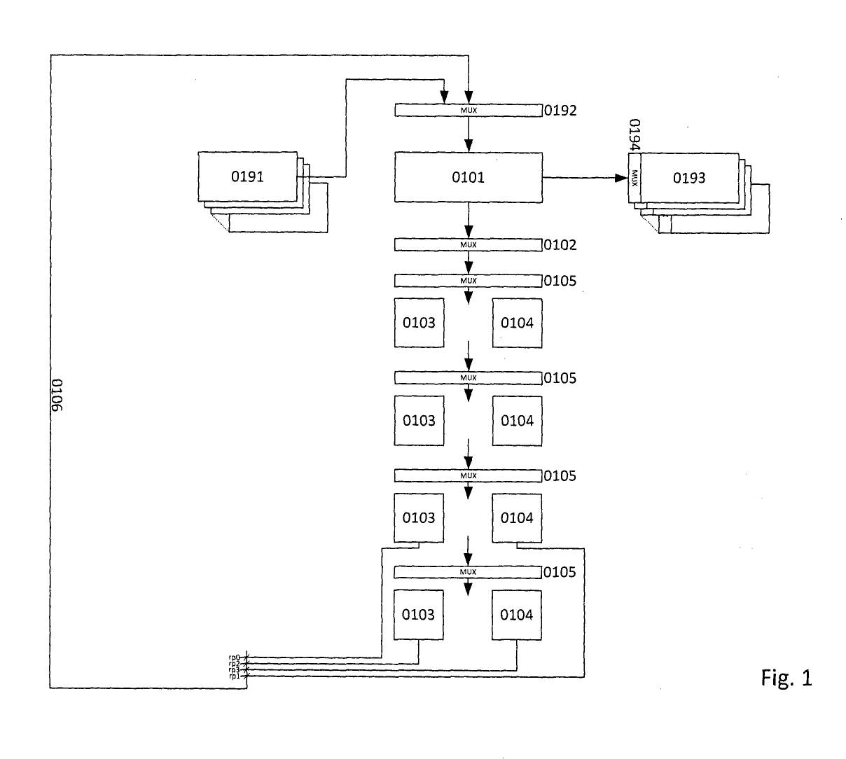

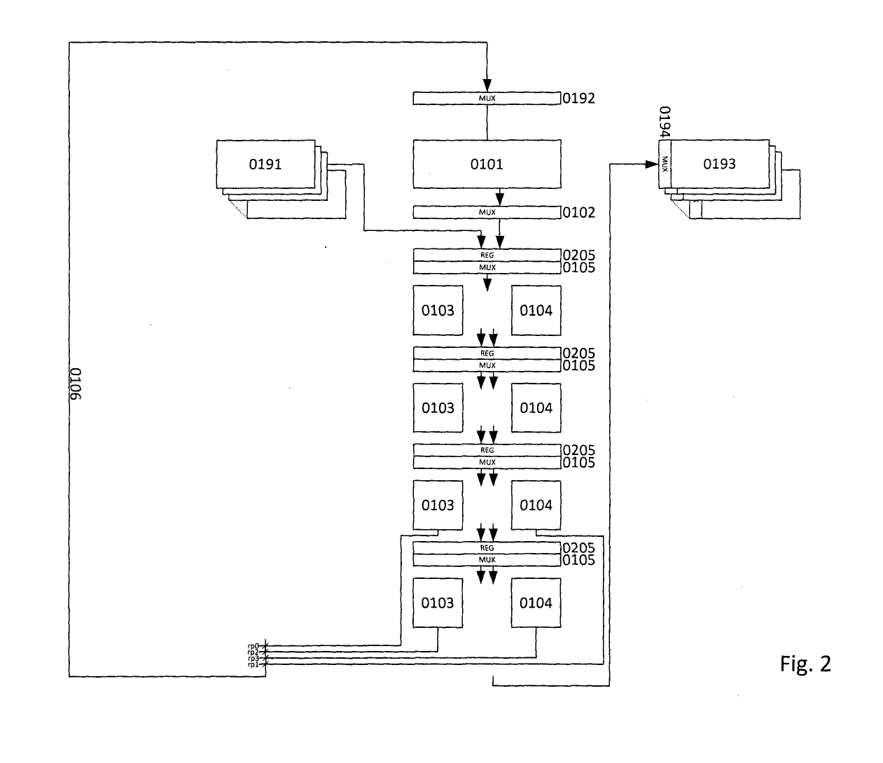

FIG. 1 and FIG. 2 show the basic architecture and operation modes which can switch between Algorithm Class 1 and Algorithm Class 2 on the fly from one clock cycle to the next.

FIG. 1 shows the operation of the inventive processor core in the asynchronous operation mode. The register file (RF, 0101) is connected to an exemplary execution unit comprising 8 ALUs arranged in a 2 columns by 8 rows structure. Each row comprises 2 ALUs (0103 and 0104) and a multiplexer arrangement (0105) for selecting registers of the register file to provide input operands to the respectively related ALU. Data is traveling from top ALUs to bottom ALUs in this exemplary execution unit. Consequently the multiplexer arrangement is capable of connecting the result data outputs of higher ALUs as operand data inputs to lower ALUs in the execution unit. Result data of the execution unit is written back (0106) to the register file. In the asynchronous operation mode data crosses the execution unit from the register file back to the register file asynchronously within a single clock cycle.

A plurality of Load/Store Units are connected to the register file. Load Units (0191) provide data read from the memory hierarchy (e.g. Level-1, Level-2, Level-3 cache, and main memory and/or Tightly Coupled Memories (TCM) and/or Locally Coupled Memories (LCM)) via a multiplexer arrangement (0192) to the register file (0101).

Store Units (0193) receive data from the register file and write it to the memory hierarchy.

It shall be noted that in this exemplary embodiment separated Load and Store Units are implemented. Nevertheless general purpose Load/Store Units being capable of loading or storing of data as known in the prior art can be used as well. While the load/store operations, particularly at least the major part of the address generation, is performed by the load (0191) and/or store units (0193) preferably all ALUs can access data loaded from by a load unit or send data to a store unit. To compute more complex addresses, even at least a part of the address calculation can be performed by one or more of the ALUs and be transmitted to a load and/or store unit. (Which is one of the major differences to the ADRES architecture, see [17]).

FIG. 2 shows the operation of the same processor core in (synchronous or) pipelined operation mode. Registers (0205) are switched on in the multiplexer arrangement 0105 so that the data is pipelined through the execution unit. Each ALU has one full clock cycle for completing its instruction—compared to the asynchronous operation mode in which all ALUs together have to complete their joint operation within the one clock cycle. Respectively—in a preferred embodiment—the clock frequency of the execution unit is accordingly increased when operating in pipelined operation mode.

Result data is returned (0106) to the register file.

Another major difference to the asynchronous operation mode is that the Load/Store Units are directly connected to the execution unit. Operand data can be directly received from the Load Units (0911), without the diversion of being intermediately stored in the register file. Respectively result data can be directly sent to Store Units (0913), again without the diversion of being intermediately stored in the register file. The benefits of this direct connection between Load/Store Units and the Execution Unit are manifold, some examples are:
1. A large amount of data can be transferred from memory hierarchy to the Execution Unit and back to the memory hierarchy within a single clock cycle. The amount of data might be much larger than the amount of registers available in the register file.
2. The register file is not trashed by the data directly load from or stored to the memory hierarchy.
3. Less energy is required as the register file is not unnecessarily involved in the data movement.
4. The respective counterpart (e.g. Level-1, Level-2, Level-3 cache, and main memory and/or Tightly Coupled Memories (TCM) and/or Locally Coupled Memories (LCM)) in the memory hierarchy replaces the register file. This is very beneficial for operations on large amounts of data, as the data is located there anyhow.
5. For processing loops, no FIFO register file storing the intermediate results between the Catenae is required. Instead the respective intermediate data is written to or read from the memory hierarchy (e.g. Level-1, Level-2, Level-3 cache, and main memory and/or Tightly Coupled Memories (TCM) and/or Locally Coupled Memories (LCM)). For detailed information about loop processing, FIFO register file and Catenae reference is made to [1] and [3], which are both fully incorporated by reference for detailed disclosure.
6. Respectively (intermediate) data does not have to be pushed from or popped into the (FIFO) register file, e.g. when switching a task or thread, as it is required for the (FIFO) register file of the processor implementation according to [1] and [3]. As the data is not located in the register file but in the memory hierarchy, e.g. the Level-1 cache, a task/thread switch automatically changes the context, as e.g. the virtual address space changes with the task/thread switch. Switching the virtual address space automatically changes the reference to respective (intermediate) data, so that each task/thread implicitly correctly references its specific intermediate data. If necessary and in accordance with standard cache operation, data of previous task/threads is offloaded from the (e.g. Level-1) cache to a higher memory level and currently required data is loaded into the (e.g. Level-1) from a higher memory level. No dedicated push/pop operations are required to offload/load data from/to a register file.

The maximum operating frequency of the Execution Unit in pipelined mode is in this exemplary embodiment approximately 4- to 6-times higher than in asynchronous mode and preferably respectively increased when switching from asynchronous to pipelined mode and vice versa.

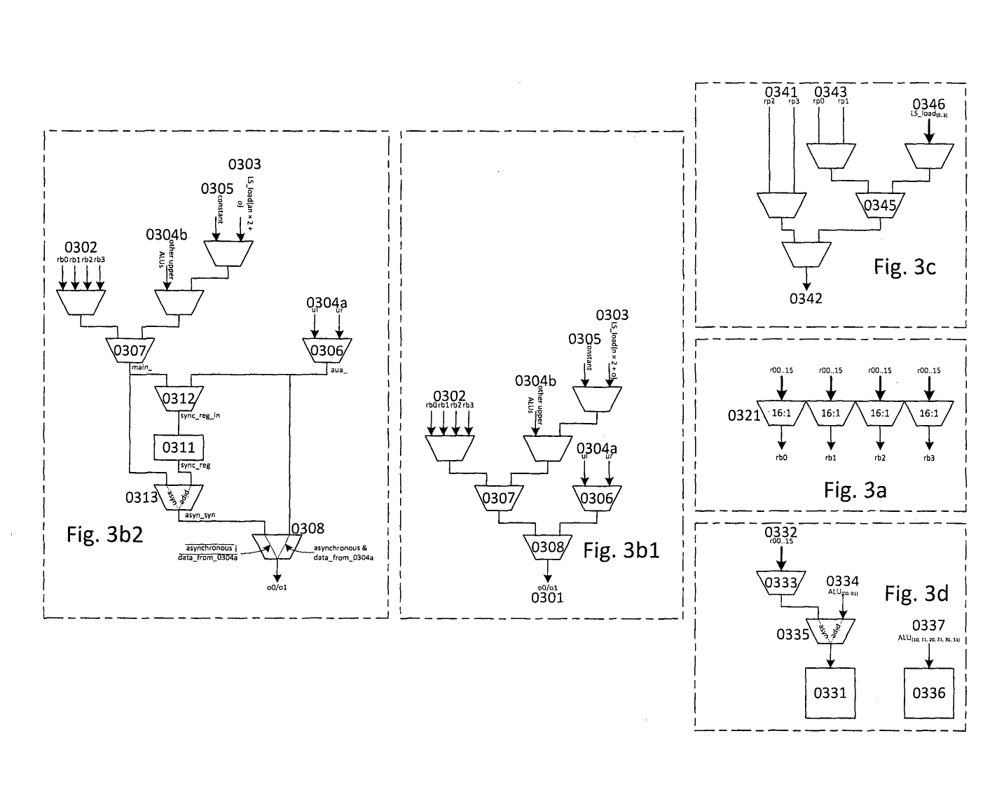

The various multiplexers are described in FIG. 3. FIG. 3b1 shows the basics for an exemplary embodiment of a multiplexer 0105.

In the preferred embodiment each ALU has 2 operand inputs o0 and o1 (0301). For each of the operands a multiplexer arrangement selects the respective operand data. For example operand data can be retrieved from

a) the register file (0302);

### b) Load Units (0303);

c) higher level ALUs (0304a and 0304b), which are in between the ALU related to the multiplexer stage and the register file;
d) the instruction decoder as a constant (0305).

In asynchronous operation mode it is important to keep the critical path as short as possible. For the multiplexer stage this is the result data from the higher level ALUs (in the left and right column in this exemplary embodiment) located directly above the related ALU. Therefore these two data inputs (ul=upper left column and ur=upper right columns; 0304a) are implemented such, that the number of multiplexers required in the multiplexer stage is minimal. All other higher ALU results are not in the critical path and can be therefore implemented using more multiplexers (0304b). Therefore the critical path comprises only two multiplexers (0306) to select between the directly upper left (ul) and upper right (ur) ALU, and 0308 for selecting between the upper ALUs (ul/ur) and the other operand sources from 0307.

In the preferred embodiment each ALU operand input might be directly connected to a Load Unit (0191) providing the oper- and data. In one embodiment, each Load Unit might be exclusively dedicate to a specific operand input of a specific ALU—and additionally to the register file via the multiplexer 0912. The direct relationship between an operand input of an ALU and the dedicated Load Unit reduced the amount of multiplexers required for selecting the Load Unit for an operand input. Other embodiments might not have this direct relationship by dedicating Load Units to specific ALU operand inputs, but have a multiplexer stage for selecting one of all of or at least one of a subset of the Load Units (0191).

The multiplexer stage of FIG. 3b1 does not support switching to the pipelined operation mode and is just used to describe an exemplary implementation of the operand source selection.

FIG. 3b2 shows a respectively enhanced embodiment for to support switching between asynchronous and pipelined operation. A pipeline register (0311) is implemented such, that still the critical path from ul and ur (0304a) stays as short as possible. A first multiplexer (0312) selects whether oper- and data from the ALUs directly above (0304a) or other sources has to be stored in the pipeline register. A second multiplexer (0313) selects between pipelined operation mode and all asynchronous operand data sources but 0304a. Ultimately select input of the multiplexer is control such that in asynchronous operation mode either data from 0304a is selected or for all other source data and the pipelined operation mode data from 0313 is selected.

Control of the multiplexer (0308) is modified such that it selects not only between the upper ALUs (ul/ur) and the other operand sources from 0307, but also selects between:
asynchronous operation mode, in which either the path (0306) from the upper ALUs (ul/ur) or the other operand sources (0307) via 0313 is selected; and
pipelined operations mode, in which always the path from the pipeline register (0311) via 0313 is selected.

This implementation allows for selecting between asynchronous and pipelined operation mode from one clock cycle to the next. The penalty in the critical path (0304a) is an increased load on the output of multiplexer 0306. The negative effect on signal delay can be minimized be implementing additional buffers for the path to 0312 close by the output of 0306. A further penalty exists in the path for all other operand sources, which is multiplexer 0313 and additional load on the output of multiplexer 0307. However, those negative effects can be almost ignored as this path is not critical.

Code analysis has shown that in asynchronous mode typically far less than half of the operands are retrieved from the register file. Other operands are constant data or data transferred as result data from one ALU to the operand data input of another ALU.

Basically the multiplexer 0302 could select one register from all available registers in the register file (0101). But, for most applications, this is regarded as a waste of hardware resources (area) and power. As shown in FIG. 3a in the preferred embodiment therefore pre-multiplexers (0321) select some operands from the register file for processing in the Execution Unit. The multiplexers 0302 then select one of the preselected data as operands for the respective ALU. This greatly reduces the number of multiplexers required for oper- and selection. The multiplexers 0321 form the multiplexer arrangement 0102 in the preferred embodiment. Code analysis has shown that approximately between number_of_ALUs/2 to number_of_ALUs/4 operands (½ to ¼ of the ALUs in the Execution Unit) are sufficient in the asynchronous operation mode, which determines the number of multiplexers 0321 in 0102. This is no limitation for the pipelined operation mode, as data from the Load Units is available as operands (and even typically and preferably used) in addition to data from the register file.

### Store Units (0193) and Store Unit Input Multiplexer (0194)

The operand multiplexer (0194) for the Store Units (0193) is shown in FIG. 3d.

In the exemplary embodiment each of the ALUs has one assigned Store Unit in pipeline operation mode. Respectively 8 Store Units are implemented receiving their data input values directly from the ALUs of the Execution Unit.

Code analysis has shown that in asynchronous operation mode fewer Store Units are required, approximately ½ to ¼ of the ALUs in the Execution. Unit. Respectively, in this exemplary embodiment, only two Store Units are used in asynchronous operation mode. These Load Units (LS_store0, LS_store1=0331) are capable of receiving their operands from the Register File (0332) via a register selecting multiplexer (0333) in asynchronous mode or from the respective ALU (ALU₀₀, ALU₀₁=0334) in the pipelined operation mode. The multiplexer 0335 selects the respective operand source paths depending on the operation mode.

The data inputs of the remaining Load Units (LS_store2 . . . LS_store7) (0336) are directly connected to the respective ALUs ALU_{(10, 11, 20, 21, 30, 31)} (0337) of the Execution Unit.

### Load Units (0191) and Register Input Multiplexer (0192)

Code analysis has shown that in asynchronous operation mode the typical ratio of Load Units to ALUs of the Execution Unit is 1:2. In this exemplary embodiment, respectively 4 Load Units are used in asynchronous operation mode. For asynchronous operation the Load Units provide their data to the Register File (0101).

Furthermore code analysis has shown that in asynchronous operation mode 4 result paths (rp0, rp1, rp2, rp3) from the Execution Unit to the Register File are sufficient. In this exemplary and preferred embodiment only the ALU result outputs of the lower two ALU stages (ALU₂₀, ALU₂₁, ALU₃₀, and ALU₃₁) are fed back to the Register File (0101).

In pipelined operation mode, however, the preferred ratio between Load Units and ALUs is 1:1, so that 8 Load Units are used in pipelined operation mode. Consequently a Load Unit might be connected to one of the operand inputs of the ALUs of the Execution Unit (see 0303 in FIG. 3b1 and FIG. 3b2). To keep the hardware overhead minimal, a Load Unit might be directly connected to an operand input, so that no multiplexers are required to select a Load Unit from a plurality of Load Units.

However, typically some ALUs require both operands from memory, particularly ALUs in the upper ALU stages, while other ALUs do not require any input from memory at all. Therefore preferably a multiplexer of crossbar is implemented between the Load Units and the ALUs, so that highly flexible interconnectivity is provided.

Loaded data can bypass the register file and is directly fed to the ALUs of the Execution Unit. Accordingly data to be stored can bypass the register file and is directly transferred to the Store Units. Analysis has shown that a 1:2 ratio between Store Units and ALUs satisfies most applications, so that 4 Store Units are implemented for the 8 ALUs of the exemplary embodiment.

It shall be noted, that in addition to the directly connected Load/Store Units bypassing the register file, ordinary load and/or store operations via the register file might be performed.

As in pipelined operation mode the main operand source and main result target is the memory hierarchy (preferable TCM, LCM and/or Level-1 cache(s)) anyhow, the 4 result paths (rp0, rp1, rp2, rp3) to the register file are also sufficient and impose no significant limitation.

A respective Register File Input Multiplexer (0192) is shown in FIG. 3d. The critical path ALU results (rp2, rp3) (0341) are connected via a short multiplexer path to the Register File (0342), the other ALU results (rp0, rp1) (0343) use an additional multiplexer (0345) which alternatively selects the 4 Load Units (LS_load₀, LS_load₁, LS_load₂, LS_load₃) (0346) as input to the register file.

For pipelined operations, stream-move-load/store-operations are supported. Basically those operations support data load or store in each processing cycle. They operate largely autonomous and are capable of generating addresses without requiring support of the Executing Unit.

The instructions typically define the data source (for store) or data target (for load), which might be a register address or an operand port of an ALU within the Execution Unit. Furthermore a base pointer is provided, an offset to the base pointer and a step directive, modifying the address with each successive processing cycle.

Advanced embodiments might comprise trigger capabilities. Triggering might support stepping (means modification of the address depending on processing cycles) only after a certain amount of processing cycles. For example, while normally the address would be modified with each processing cycle, the trigger may enable the address modification only under certain condition, e.g. after each n-th processing cycle. Triggering might also support clearing of the address modification, so that after n processing cycles the address sequence restarts with the first address (the address of the 1-st cycle) again.

The trigger capability enables efficient addressing of complex data structures, such as matrixes.

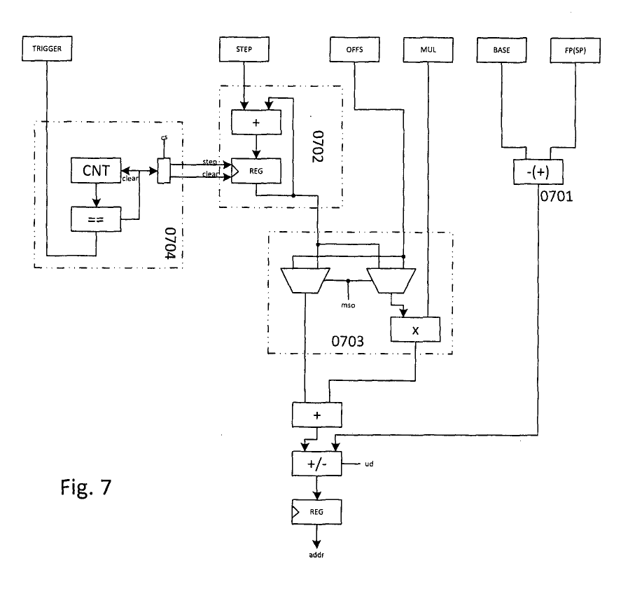

An exemplary Address Generator is described in FIG. 7.

### Arithmetic Logic Unit/Execution Unit

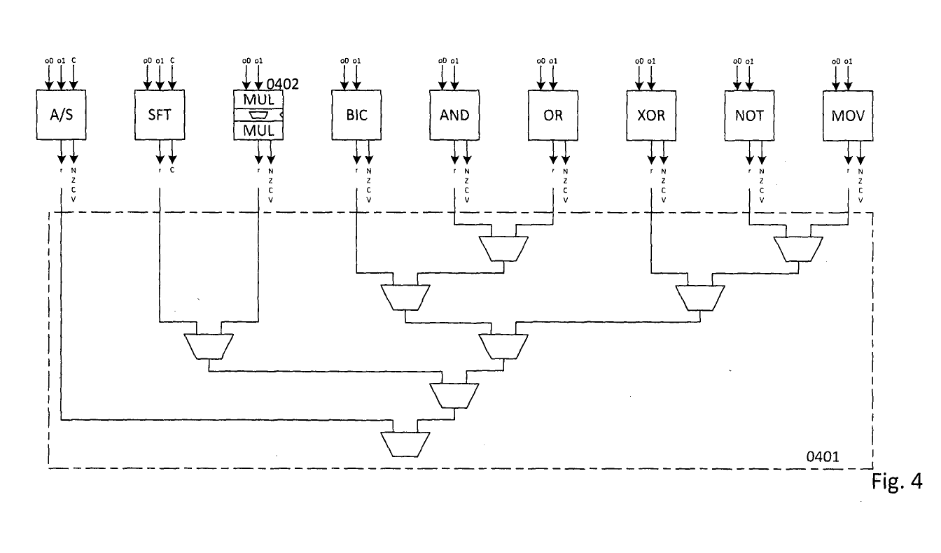

An exemplary ALU is shown in FIG. 4. While most functions are obviously implemented for a person skilled in the art, the multiplexer (0402) implementation requires further explanation.

While the multiplier is the slowest function of the ALU it has not the shortest path through the result multiplexer 0401. The reason therefore is that in most asynchronous code, multiplication is barely used. Respectively only the multiplier of the lowest ALU row is usable in asynchronous operation mode, retrieving its operand data only and directly from the Register File. Thus, the allowed signal delay of the multiplier equals the signal delay of a path through all ALUs of the complete Execution Unit.

In pipelined operation mode, which algorithms typically require a larger amount of multiplication, a pipelined multiplexer might be used in each of the ALUs of the Execution Unit. The pipelined implementation supports the respectively higher clock frequency at the expense of the latency, which is typically negligible in pipelined operation mode.

This implementation is not limited to a multiplier, but might be used for other complex and/or time consuming instructions (e.g. square root, division, etc).

### Code Generation

Code is preferably generated according to [4] and [6], both of which are incorporated by reference. As described (particularly in [4]) instructions are statically positioned by the compiler at compile time into a specific order in the instruction sequence (or stream) of the assembly and/or binary code. The order of instructions determines the mapping of the instruction onto the ALUs and/or Load/Store Units. For determining the mapping the ZZYX architecture uses the same deterministic algorithm in the compiler for ordering the instructions and the processor core (e.g. the Instruction Decode and/or—Issue Unit). By doing so, no additional address information for the instruction's destination must be added to the instruction binary code for determining the target location of the instruction. Further it allows using well established instruction set architectures (ISA) of industry standard processors and simultaneously provides for binary code compatibility of ZZYX enhanced and original processors. All those benefits are major advantages over the TRIPS architecture (see [18]). Further, TRIPS' instructions bits required for defining the destination (mapping) of each instruction are a significant architectural limitation significantly limiting the upward and downward compatibility of TRIPS processors. ZZYX processors are not limited by such destination address bits.

Consequently ZZYX an instruction block (i.e. a Catena, for further details reference is made to [3]) has—in difference to TRIPS' “Hyperblocks”—no fixed size.

Preferably Catenae use no headers for setting up the intercommunication between units (e.g. stores, register outputs, branching, etc.) but the respective information is acquired by the Instruction Decoder by analysing the (binary) instructions, for further details reference is made to [4] and [6].

Operation on Data Blocks Vs. Operation on Single Data/Rolling Issue Vs. Multi-Issue

Processing blocks of data has been discussed in detail in [1] which is incorporated by reference. Processing a plurality of data with the same set of instructions significantly reduces the required bandwidth in the Instruction Fetch and Decode path. Rolling instruction issue (reference is made to the rotor in [1]) overlays data processing and instruction issue in a way such that typically only one or even less than one instruction per clock cycles needs to be fetched, decoded, and issued.

However, processing rather small blocks of data or only a single data word with a set of instructions quickly leads to starvation as the Instruction Fetch and Decode path may have insufficient bandwidth to provide the required amount of instructions per clock- or processing-cycle.

For avoiding or minimizing the risk of starvation when processing small data blocks or even single data a compressed instruction set might be provided. Compressed instruction sets are, for example, known from ARM's Thumb instructions. A compressed instruction set typically provides a subset of the capabilities of the standard instruction set, e.g. might the range of accessible registers and/or the number of operands (e.g. 2 address code instead of 3 address code) be limited. Compressed instructions might be significantly smaller in terms of the amount of bits they required compared to the standard instruction set, typically a half (1:2) to a quarter (1:4). Preferably only the most frequent and/or common instructions used in loops, inner-loops in particular, and standard data processing should be provided in the compressed instruction set. This allows for efficient implementation of the multi-issue mechanics without requiring a high bandwidth or overly complex processor front-end (i.e. Instruction Fetch and Decode). Not only the risk of starvation processing small data blocks or single data is significantly reduced but also the efficiency, in terms of size and energy consumption, of the code for larger data blocks and particularly loops is greatly improved.

Rather complex and/or seldom used instructions might have no compressed counterpart as the penalty in terms of execution cycles appears acceptable compared to the instruction set's complexity.

Compilers preferably switch in the code generation pass to the compressed instruction set if loop code, particularly inner-loop code, and/or stream-lined data processing code is generated. Particularly, compilers may arrange and align the code such, that the processor core can efficiently switch between the execution modes, e.g. between normal execution, multi-issue, and/or loop mode. Simultaneously the processor might switch to asynchronous processing for e.g. single data (and possibly for some small data blocks) and to synchronous processing for large data blocks (and possibly for some small data blocks).

### Clock Generation and Distribution

In asynchronous operation mode the signal path delay of a 2 columns by 4 rows Execution Unit requires and approximately 4- to 6-times lower clock frequency than in pipelined operation mode. Larger or smaller execution units have respective higher are lower signal path delay in accordance with the longest (critical) path through the respective number of ALUs.

In order to switch between the operation modes within one clock cycle, Phase-Locked-Loops are insufficient as they require a rather long time to lock to the respective frequency. Therefore in the preferred embodiment, the clock is generated using a counter structure dividing the clock for asynchronous operation mode.

In most embodiments the Execution Unit (EXU) and Register File (RF) is supplied with the switchable clock, while other parts of the processor keep operating at the standard clock frequency. For example in asynchronous operation mode the instruction fetch and decode units have to supply all ALUs of the Execution Unit within a single Execution Unit clock cycle with new instructions; compared to the pipelined operation mode, in which only the ALUs of a row are supplied with new instructions. For an exemplary Execution Unit having a 2×4 ALU arrangement this means that in pipelined mode instructions to 2 ALUs are issued within a single clock cycle, while in asynchronous operation mode instructions to 8 ALUs must be issued within the single (but now reduced) clock cycle. This difference of a factor of 4 can be balanced by keeping the clock of the instruction fetch and decode unit(s) running at the standard non-reduced clock frequency.

In the preferred embodiment in asynchronous operation mode the Load/Store Unit(s) are connected directly with the register file (see FIG. 1). Therefore the clock frequency of the Load/Store Units might be reduced in accordance with the clock frequency of the Execution Unit (EXU) and Register File (RF). Consequently the clock frequency of the memory hierarchy, at least the Level-1 cache(s), Tightly Coupled Memories (TCM), and/or Locally Coupled Memories (LCM) might be accordingly reduced with the respective power savings.

### Multiple Concurrent Accesses to Data on the Stack

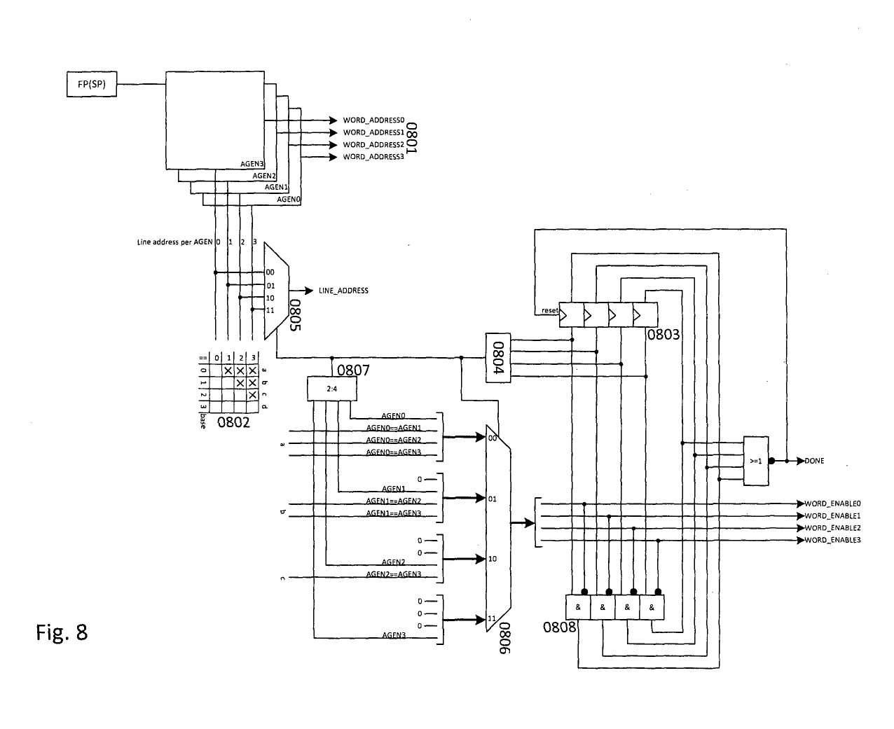

Increasing the memory transfer bandwidth by providing the capability of concurrent parallel memory accesses is a major aspect of the ZZYX architecture. Reference is particularly made to [1], [2], [4], and [5] which are fully incorporated by reference and in which several aspects are discussed. Particularly the technology described in [2], e.g. FIGS. 8-10 is highly efficient for e.g. accessing data on the heap. Details of memory architectures, including stack and heap, shall not be discussed in this application. Stack and heap memory are well known terms for one skilled in the art. For details also reference is made to [7], and [8].

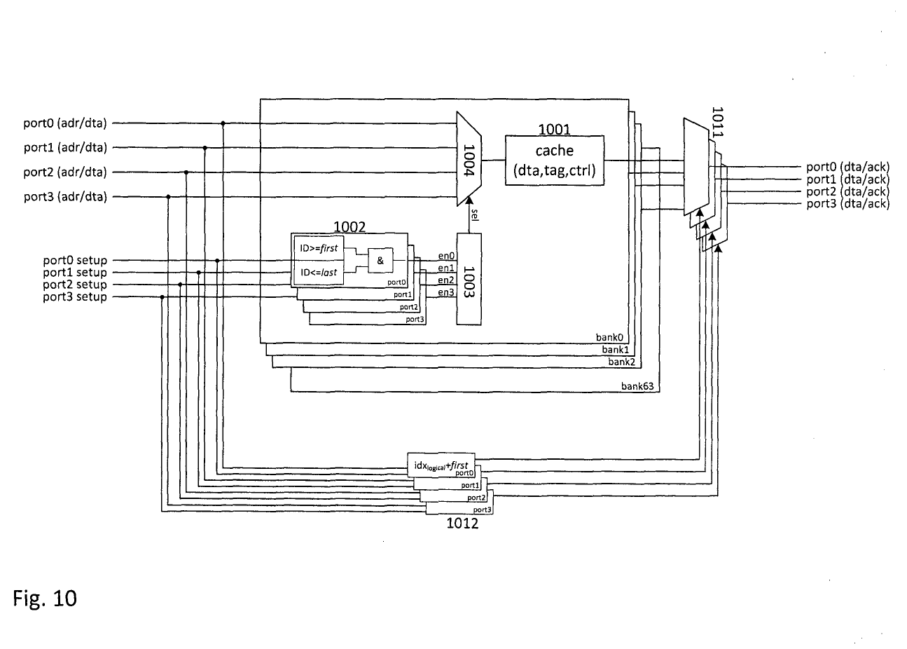

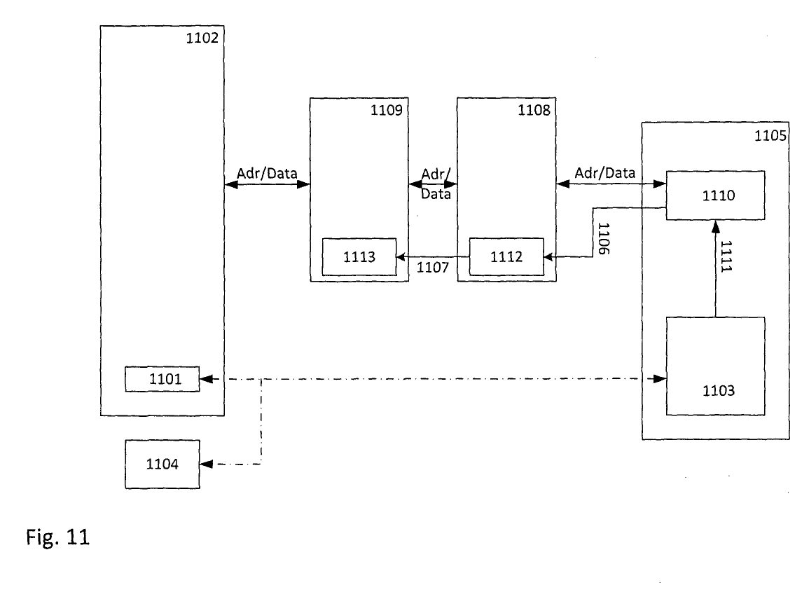

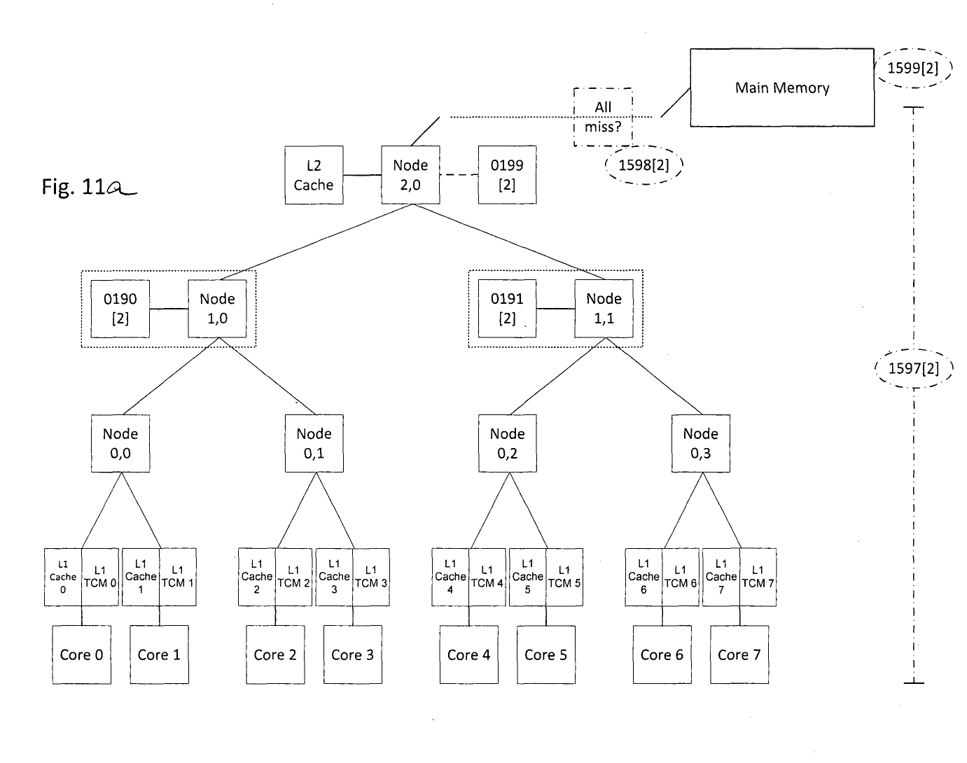

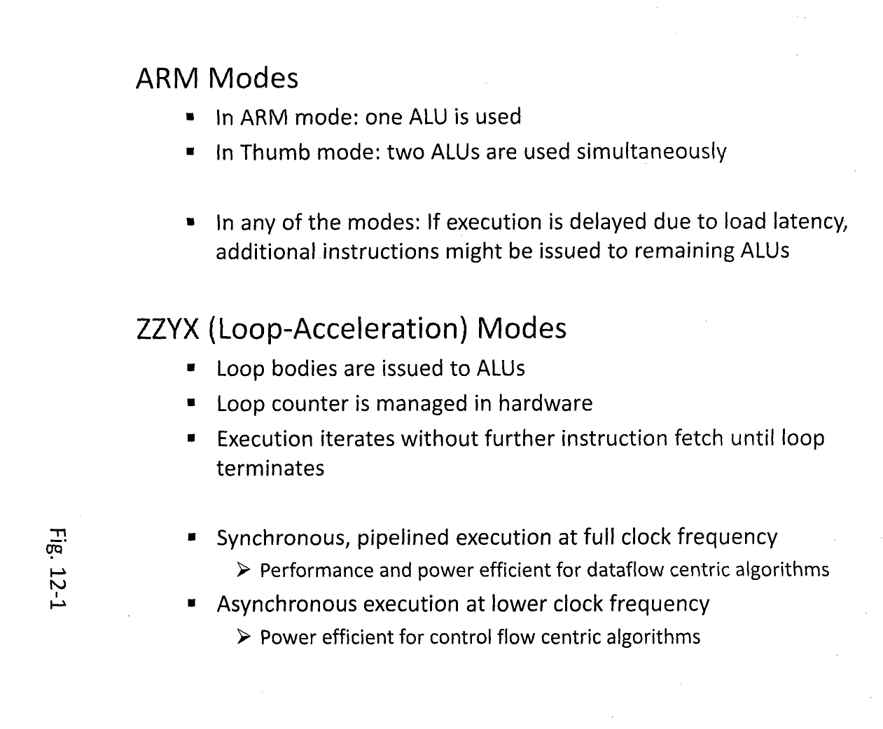

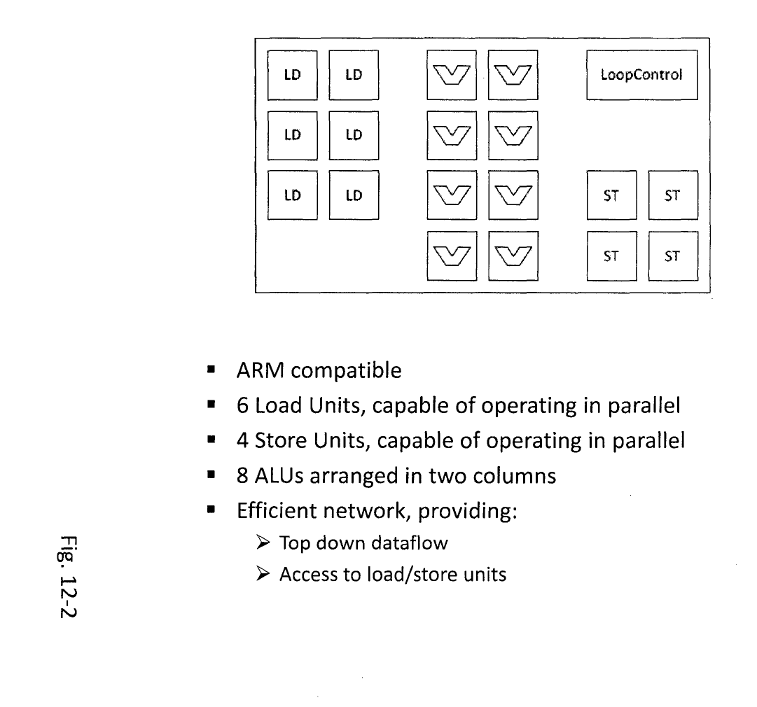

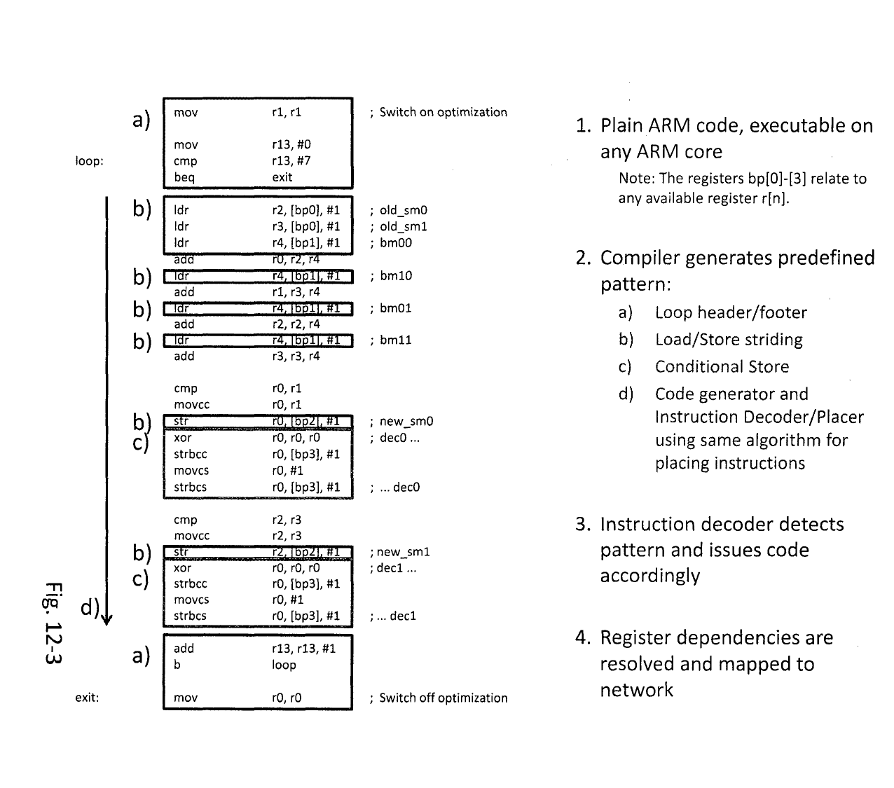

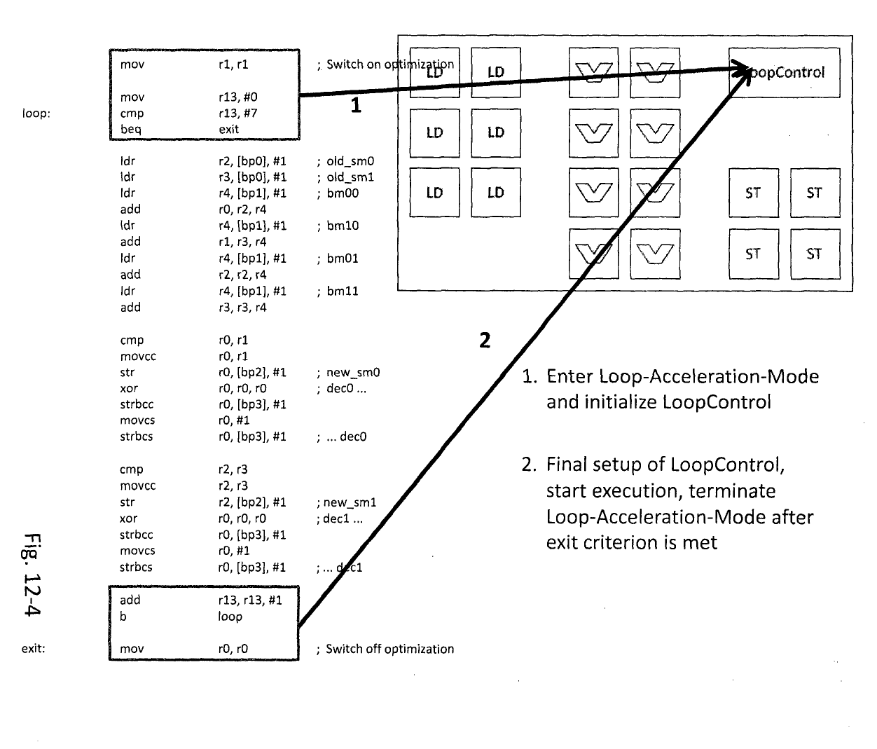

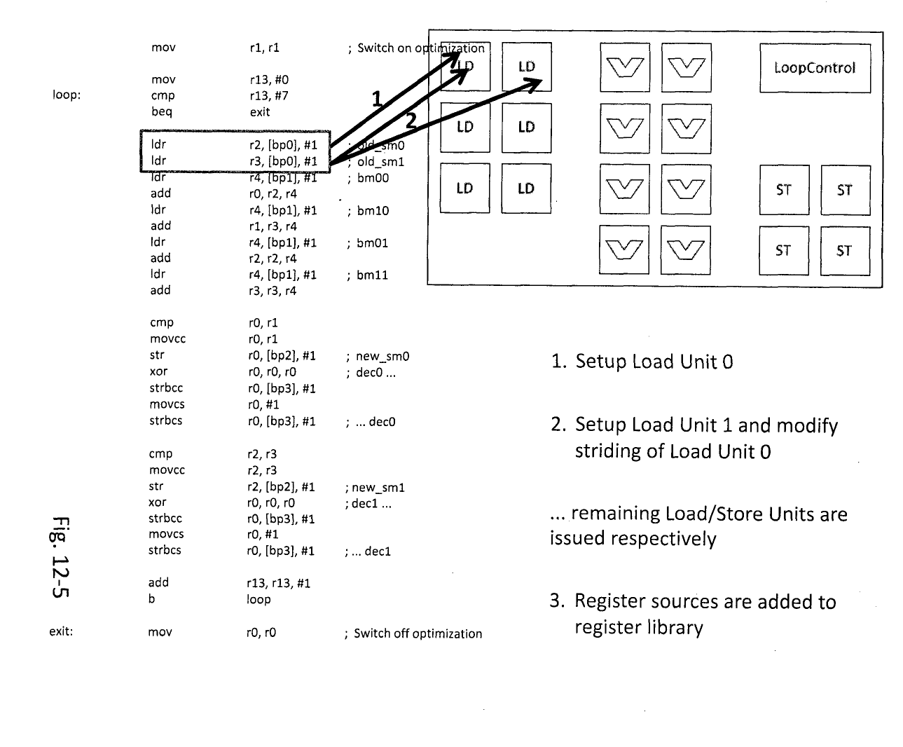

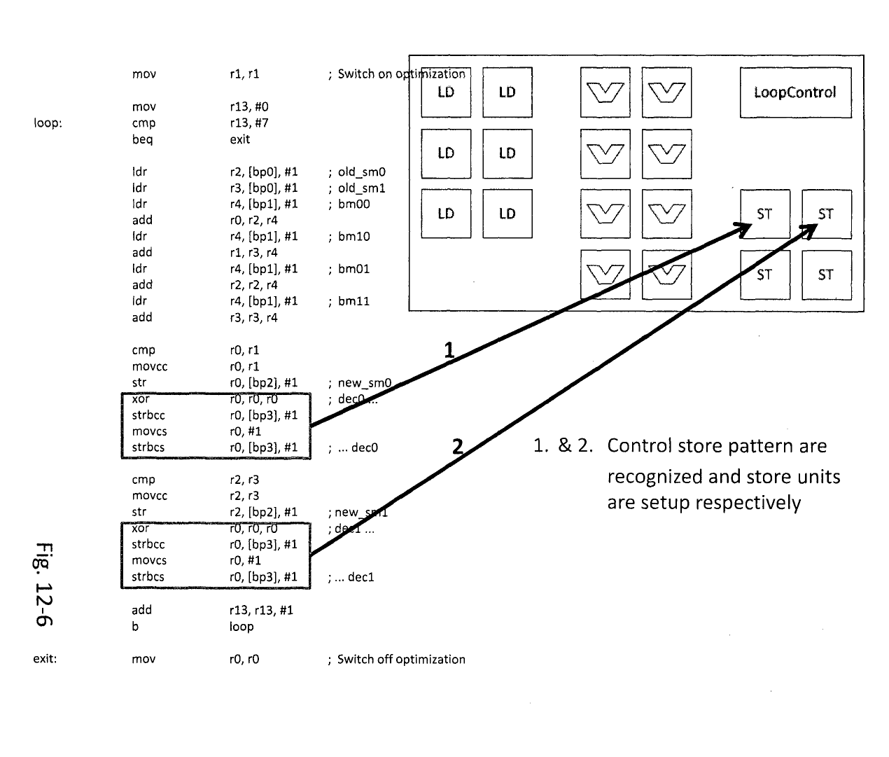

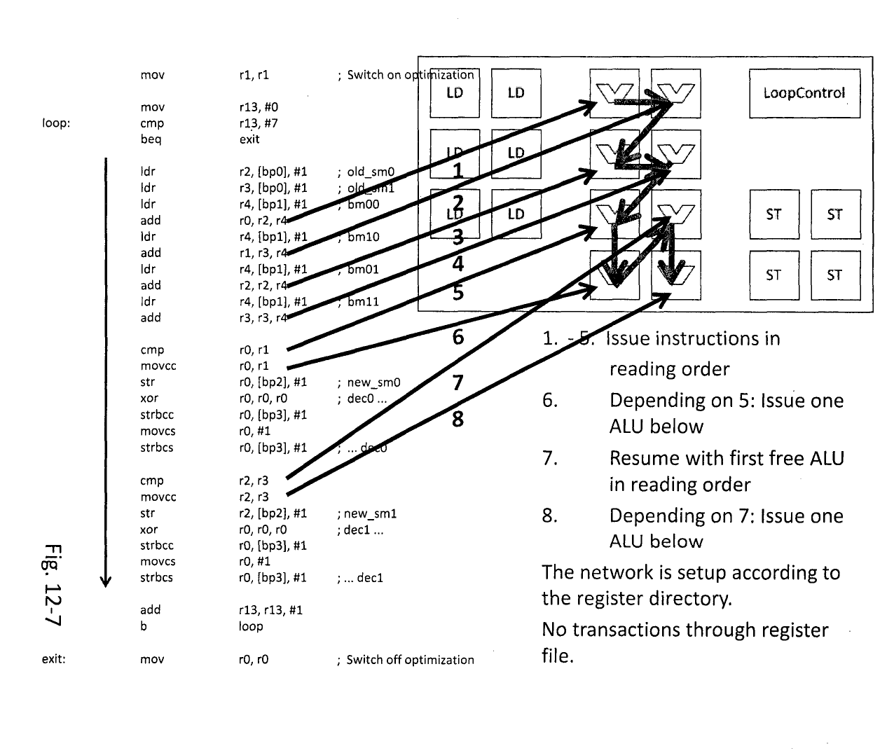

While the previously described memory implementations and methods, particular reference is made to [2], e.g. FIGS. 10 and 11, can be successfully implemented for heap data, the addressing is less suitable for stack data.

The prior art understands and/or requires the stack to be located in a monolithic memory arrangement. The stack for a thread and/or task is located entirely or at least at function level in a monolithic and often even continuous memory space.

Addressing within the stack is stack pointer (SP) or depending on the compiler and/or processor implementation frame pointer (FP) relative. Within this specification a Frame Pointer (FP) is used for pointing to the start (which is according to typical conventions the top) of a frame (i.e. an Activation Record), while the Stack Pointer is used to point to anywhere within the frame. One skilled in the art is familiar with Frames/Activation Records, anyhow for further details reference is made to [7], and [9]. As the frame pointer typically points to the highest address of the frame (typical stack implementations grow from top to bottom) for calculating relative addresses, the offset is in this specification subtracted from the frame pointer (FP). Compilers and/or processors not supporting frame pointer use solely stack pointer based addressing, for which typically the offset is added to the stack pointer.

It shall be noted that for addressing an element within a data structure it is left open to the compiler implementation whether the element is below or above the base address of the element, therefore the elements relative address is either subtracted or added to the structure's base address (e.g. ±ElementOffset).

Address operations for accessing data might be of the type FramePointer−Offset, with Offset being the relative address of the specific data within the stack. Data within more complex data structures might be addressed e.g. via FramePointer−StructureOffset±ElementOffset, with OffsetStructure pointing to the data structure on the stack and the second offset OffsetData pointing to the data within the data structure. For example FramePointer−StructureOffset(array)±ElementOffset(index) addresses element index of array array (array[index]).

While it appears less important to support concurrent accessing of random data on the stack, significant performance increase is achievable by the capability of transferring data to or from major data structures on the stack in parallel. For example a Fourier transformation or matrix multiplication would perform significantly faster if all input data could be read simultaneously from the stack in a cycle and ideally even the output is written to the stack in the same cycle.

This requires breaking up the monolithic concept of the stack by distributing its data among multiple memory banks each being independently accessible. Ideally this is implemented in a way causing minimum overhead and avoiding coherence issues; the overhead for coherence management would significantly reduce the potential performance benefit.

It is proposed still to manage the stack as a continuous monolithic memory space, but to partition the stack content of each Activation Record (i.e. Frame)—for details see e.g. [7] Chapter 7.2—into a plurality of sections. Each or at least some of the performance critical data structures (i.e. those which benefit most from concurrent accessibility) forming a section. Some data structures which are (mostly) mutually exclusively accessed might be combined into a joint section, so to minimize the overall amount of sections.

At runtime each section is assigned to a dedicated Level-1 cache (or Level-1 Tightly Coupled Memory; for details reference is made to [2]).

In case the executing processor does not comprise sufficient dedicated Level-1 memories (e.g. caches or TCM), the hardware might merge at runtime groups of the sections (joint sections) and map those groups onto the existing Level-1 memories, such that each group (joint section) is located in one dedicated Level-1 memory. This certainly limits the concurrent accessibility of data but enables a general purpose management of the sections: The actual and ideal amount of sections depends on the specific application. Some applications might require only a few sections (2-4), while others may benefit from a rather large amount (16-64). However, no processor architecture can provide an infinite amount of Level-1 memories fitting all potential applications. Processors are rather design for optimum use of hardware resources providing the best performance for an average of applications—or a set of specific “killer applications”, so that the amount of Level-1 memories might be defined (and by such limited) to those applications. Furthermore, different processors or processor generations might provide different amounts of Level-1 memories, so that the software ideally has the flexibility operating with as many Level-1 memories as possible, but still performing correctly on a very few, in the most extreme case only one, Level-1 memory/memories.

However, several methods might be applied to keep the most critical data structures independent and merge preferably those sections which lack of concurrent accessibility has minimum performance impact.

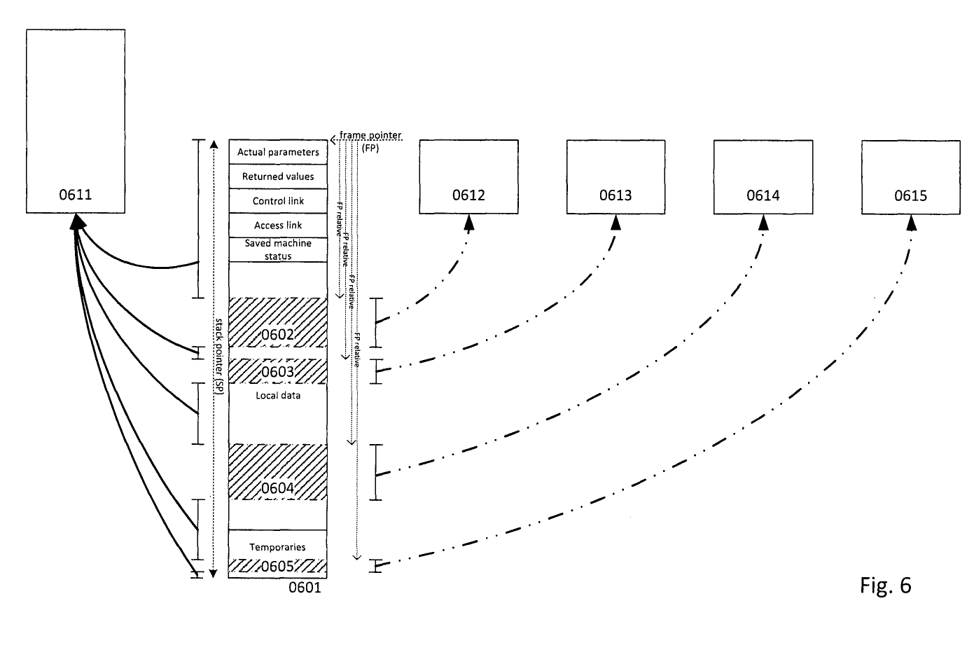

The invention is shown in FIG. 6. The monolithic data block (0601) of an Activation Record (i.e. Frame) comprises typical stack data (see e.g. [7] FIG. 7.5: A general activation record). In this exemplary embodiment frame pointer (FP) points to the start of the frame, while the stack pointer is free to point to any position within the frame.

In the prior art, all contents of the Activation Record is managed by the same single Level-1 data cache. However, according to this invention, still a main Level-1 data cache (0611) manages and stores the major parts of the Activation Record, but additionally further independent Level-1 caches (0612, 0613, 0614, 0615) store data sections (0602, 0603, 0604, 0605) which benefit from independent and particularly concurrent accessibility.

The formerly monolithic stack space is distributed over a plurality of independent Level-1 memories (in this example caches) such that each of the caches storing and being responsible for a section of the Activation Record's address space. The independent Level-1 memories might be connected to a plurality of independent address generators, particularly each of the Level-1 cache might be connected to an exclusively assigned address generator, such that all or at least a plurality of Level-1 memories are independently and concurrently accessible.

The data sections are defined either by address maps (which are preferably frame pointer relative) or dedicated base pointers for assigning memory sections to dedicated Level-1 memories; details are described below.

Data access to those explicitly defined data sections are automatically diverted to the respective Level-1 memories. Data accesses to all other ordinary addresses (not within any of the dedicated data sections) are managed by the ordinary standard Level-1 memory (typically Level-1 data cache).

### Applicability on Heap Data

This invention is applicable for optimizing access to heap data by distributing it into a plurality of memories (e.g. Level-1 cache, TCM, LCM, reference is made to [2] for details on LCM). This invention might be used additionally or alternatively to the address range/Memory Management Unit based approach described in [2].

### Defining the Sections

In difference to heap, the location of stack data can be determined at compile time. This is true even for random size structures, as at least the pointer(s) to the respective structure(s) are defined at compile time (see e.g. [7] Chapter 7.2.4). Two exemplary approaches for defining sections are:

1. Providing a stack pointer relative memory map describing the location of each section. Such map might be provided either as part of the program code or as data structure. For example a map might be organized as such:

An instruction map might be implemented defining the section number and the stack relative memory area:
map section#, StartAddress, EndAddress

In one embodiment, section# might be an 8-bit field supporting up to 2⁸ independent sections, and both the StartAddress and EndAddress are 16-bit fields. Other embodiments might use smaller or larger fields, e.g. 10-bits for section# and 32-bits for each StartAddress and EndAdress. Particularly if EndAddress is calculated relative to the StartAddress, as shown below, the EndAddress field might be smaller than the StartAddress field, e.g. 32-bits for the StartAddress and 24-bits for the EndAddress.

In one embodiment the actual addresses might be calculated at runtime as such: ActualStartAddress=FramePointer−StartAddress and ActualEndAddress=FramePointer±EndAddress.

However, in another embodiment the addresses might be calculated as such: ActualStartAddress=FramePointer−StartAddress and ActualEndAddress=ActualStartAddress+EndAddress. This allows for a smaller EndAddress field, as the range of the field is limited to the size of the data structure.

If the map is provided as a data field, which might be one word comprising the entries section#, StartAddress and EndAddress. If the size of the entries is too large for a single word, two or more data words might be used, for example:

| Single word: | | |
|---|---|---|
| MSB | LSB | |
| section# | StartAddress | EndAddress |
| Multi-word: | | |
| MSB | LSB | |
| section# | EndAddress | |
| StartAddress | | |

A pointer is provided within the code to the map, so that it can be read for setting up the memory interfaces and the address generators.

Preferably a dedicated and independent Level-1 memory is assigned to each section allowing for maximum concurrency. However, depending on the processor implementation, sections might be grouped and each group has a dedicated and independent Level-1 memory assigned. This concept provides an abstraction layer between the requirements of the code for perfect execution and maximum performance and the actual capabilities of the processor, allowing for cost efficient processor designs.

2. Using dedicated base address pointers, each pointer indicating the specific section to be used. Instead using address ranges for associating Level-1 memories to data, base pointer identifications are used. Each segment uses a dedicated base pointer, via which unique identification (base pointer ID) a Level-1 memory is associated to a section. As described above sections might be grouped and each group has a dedicated and independent Level-1 memory assigned, with the above described features. The base pointers are used in the load or store instructions for identifying sections.

For calculating the actual address various design options exist, e.g. might the base address be preset by the base address of the data structure, which might be BaseAddress=FramePointer−DataStructureBaseAddress, with ActualAddress=BaseAddress±ElementOffset. In another embodiment, the base address might be relative to the stack pointer and the address generator computes the actual address as follows: ActualAddress=StackPointer−DataStructureBaseAddress±ElementOffset.

For example:
ld r0, bp7=fp-4 loads data from the frame pointer relative position 4 (fp-4) to register r0 using a base pointer with the identification (ID) 7.

st bp4=fp-4, r0 respectively stores the content of r0.

ld r0, bp7=fp-r7 loads data from the frame pointer relative position computed by subtracting the value of r7 to the gvalue of the frame pointer (fp-r7) to register r0 using base pointer with the ID 62.

st bp7=fp-r7, r0 respectively stores the content of r0.

### Difference Between the Two Exemplary Approaches

The first method requires range checking of the generated address, for referencing an address to a specific section and the respective Level-1 memory (e.g. cache or TCM). This additional step consumes time (in terms of either signal delay or access latency) and energy. On the other hand, it might provide better compatibility with existing memory management functions. A major benefit of this method is that any address generator might point to any address in the memory space, even to overlapping sections, without confusing the integrity, as the association is managed by the range checking instance, assigning a Level-1 to an address generator dynamically depending on the currently generated address.

The second method references the sections a priori just by the respective base pointer, establishing a static address generator to Level-1 memory assignment. No checking of the address range is required. This embodiment is particularly for embedded processors more efficient. The downside of this method is that if two base pointers point to overlapping address ranges, the assignment of the sections and accordingly the memory integrity will be destroyed, either causing system failure or requiring additional hardware for preventing. However, as the memory map (i.e. location of data) on the stack is determined at compile time and quasi static, overlapping address ranges might be simply regarded as a programming error; as a stack overflow already is. It depends on the implementation of the Level-1 memory architecture of the processor then, how the error is treated. For example an exception might be generated or simply two different Level-1 memories might contain the same data, causing incoherent data, if data is modified or even no problem at all, if the respective data is read only. Particularly the duplication of read only data is a powerful feature of this implementation, allowing for concurrent access to constant data structures.

In other embodiments, even coherence protocols might be implemented or additionally range checking. However, both are not preferred given the deterministic memory layout of the stack and the hardware overhead implied by these measures.

Directory of Base Pointer and/or Section#

Ideally means are provided for defining section which should be mutually exclusively used and others which might share a joint Level-1 memory. This allows for optimal execution on a variety of processor hardware implementations which support different amounts of independent Level-1 memories.

In one exemplary embodiment, the based pointer reference numbers or section identification (ID) (section#) form a directory so that areas are defined within the number range which shall use mutually exclusive Level-1 memories, but numbers within an area might share the same memory. Depending on the processor capabilities, the areas are more or less fine granular.

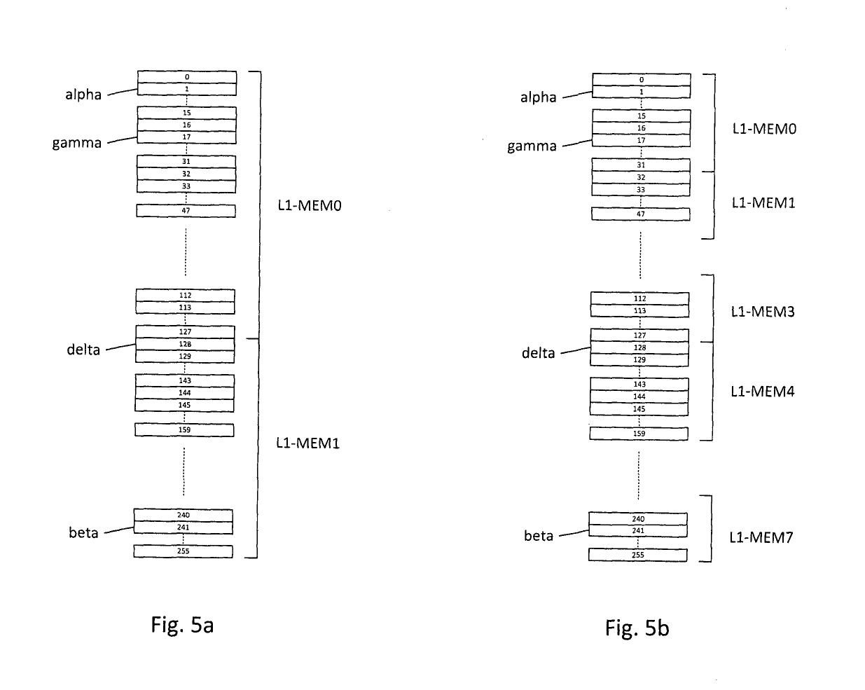

For example, in one embodiment of the current invention, an ISA (Instruction Set Architecture) of a processor family might support 8-bit section identification (section#) or 256 base pointers respectively. A first implementation of a processor of said family supports 2 Level-1 memories (L1-MEM0 and L1-MEM1). As shown in FIG. 5a, the directory is split into two sections, a first one comprising the numbers 0 to 127 and a second one with the number 128 to 255. The first section references the first Level-1 memory (L1-MEM0) of this processor, while the second section references the second Level-1 memory (L1-MEM1). Accordingly the programmer and/or preferably compiler will position the most important data structures which should be treated mutually exclusive for allowing concurrent access such that pairs of data structures which benefit most from concurrent access (the first and the second data structure should be concurrently accessible) into the first and second section of the directory. For example an application has two data structures alpha and beta which should be concurrently accessible. The compiler assigns section ID or base pointer 1 to alpha and 241 to beta, so that alpha will be located in the first and beta in the second Level-1 memory.

Further the application might comprise the data structures gamma and delta. Gamma might benefit only very little or not at all from being concurrently accessible with alpha, but benefits significantly from being concurrently accessible with beta. Therefore gamma is placed in the first section (e.g. section ID or base pointer 17). Delta on the other hand benefits significantly from being concurrently accessible with gamma. It would also benefit from being concurrently accessible with beta, but not as much. Consequently delta is placed in the second section, but as far away from beta as possible; respectively the section ID or base address 128 is assigned to delta.

A more powerful (and expensive) processor of this processor family comprises 8 Level-1 memories. The directory is respectively partitioned into 8 sections: 0 to 31, 32 to 63, 64 to 95 . . . and 224 to 255. The pairs alpha-and-beta, and delta-and-gamma will again be located in different Level-1 memories. Gamma and alpha will still use the same Level-1 memory (L1-MEM0). However, delta and gamma will now also be located in different sections and respectively Level-1 memories, as delta will be in section 224 to 255 (L1-MEM7), while gamma is in section 128 to 159 (L1-MEM4).

Consequently, the directory partitioning of the reference space (e.g. section ID or base pointer reference) enables the compiler to arrange the memory layout at compile time such, that maximum compatibility between processors is achieved and the best possible performance according to the processor's potential is achievable.

### Address Generation

An exemplary address generator (AGEN) is shown in FIG. 7.

The base address (BASE) is subtracted to the Frame Pointer (FP) (or added to the Stack Pointer (SP), depending on the implementation) providing the actual base address (0701).

A step logic (0702), comprising a counter with programmable step width (STEP), produces a new offset for each cycle.

A basic offset (OFFS) is provided for constantly modifying the actual base address (0701).

In an advanced embodiment, for extending the offset range or step width, a multiplicand (MUL) is provided which can be multiplied (0703) either to the computed step or offset. The instruction bit mso defines, whether step or offset is multiplied.

Step and offset are added, becoming the base address modifier (0704), which is then added/subtracted from 0701 to generate the actual data address (addr). The instruction bit ud defines whether an addition or subtraction is performed.

The trigger logic (0704) counts (CNT) the amount of data processing cycles. If the amount specified by TRIGGER is reached, the counter (CNT) is reset and the counting restarts. At the same time depending on the instruction bit cs the step counter in 0702 is either triggered (step) or reset (clear). The trigger feature might be disabled by an instruction bit or by setting TRIGGER to a value (e.g. 0) which triggers step for each processing cycle.

It shall be explicitly noted, that in a preferred embodiment, the Load and/or Store Units even support concurrent data transfer to a plurality of data words within the same Level-1 memory. A respective memory organization is specified in [5], which is fully incorporated by reference for detailed disclosure. It shall be expressively noted, that the memory organization of [5] can be applied on caches, particularly on the Level-1 caches described below.

A respective address generation for a Load and/or Store Unit is exemplary shown in FIG. 8. 4 address generators according to FIG. 7 are implemented using a common frame/stack pointer. Other settings might be either common or address generator specific.

The generated addresses (addr) are split into a WORD_ADDRESS part (e.g. addr[m−1:0]) and a LINE_ADDRESS part (e.g. addr[n−1:m]), depending on the capabilities of the assigned Level-1 memory.

In this exemplary embodiment, the connected Level-1 memory shall be organized in 64 lines of 256 words each. Respectively the WORD_ADDRESS is defined by addr[7:0] and the LINE_ADDRESS by addr[13:8]. Each word address is dedicatedly transferred (0801) to the Level-1 memory.

It must be ensured that all generated line addresses are the same to perform correct data accesses. If not, data transfer for groups of same line addresses must occur sequentially.

This is done by a compare-select logic as shown in FIG. 8. The line addresses are compared by 6 comparators according to the matrix 0802 producing comparison result vectors. The crossed elements of the matrix denote comparisons (e.g. LINE_ADDRESS0 is compared with LINE_ADDRESS1, LINE_ADDRESS2, and LINE_ADDRESS3, producing 3 equal signals bundled in vector a; LINE_ADDRESS1 is compared with LINE_ADDRESS2 and LINE_ADDRESS3, producing 2 equal signals bundled in vector b; and so on).

4 registers (0803) form the selector mask of the selector logic. Each register has a reset value of logical one (1). A priority encoder (0804) encodes the register values to a binary signal according to the following table (‘0’ is a logical zero, ‘1’ a logical one, and ‘?’ denotes a logical don't care according to Verilog syntax):

| Register values | Encoded signal |
|---|---|
| 1111 | 00 |
| 01?? | 01 |
| 001? | 10 |
| 0001 | 11 |
| 0000 | undefined |

Accordingly multiplexer 0805 selects the LINE_ADDRESS to be transferred to the Level-1 memory and multiplexer 0806 selects the comparison result vectors to be evaluated.

The comparison result vector selected by 0806 carries a logical one ‘1’ for all line addresses being equal with line address currently selected by 0805. Respectively the vector enables the data transfers for the respective data words (WORD_ENABLE0 . . . 3). Accordingly, via the 2:4 decoder 0807, a logical 1 is inserted for the currently used comparison base (see 0802).

The enabled words are cleared from the mask, by setting the respective mask bits to logical ‘0’ zero by a group of AND gates (0808) and storing the new mask in the registers 0803. Respectively, the new base for performing the selection is generated by 0804 in the next cycle.

Typically groups of matching LINE_ADDRESSes are enabled in each cycle. Best case, all LINE_ADDRESSes match and are enabled in a single cycle. Worst case, no two LINE_ADDRESSes match and each requires a dedicated cycle. Once all LINE_ADDRESSEs have been processed and the mask is respectively all zero ‘0’, a DONE signal is generated and the mask is reset to all ones. All data transfers have been performed and data processing can continue with the next step.

Not shown is the logic required for ignoring unused LINE_ADDRESSes, as it is not needed for the basic understanding of the concept and would rather confuse the diagram and explanation of FIG. 8. Various straight forward implementations for this logic exist and are obvious for one skilled in the art.

### Banked Cache

Predicting the amount of memory space ideally required for each of the Level-1 memories might be hard if not even impossible to predict, and will certainly differ between algorithms and applications.

In one embodiment, a Level-1 cache might be implemented comprising of a plurality of banks, while each or at least some of the banks can be dedicated to different address generators, so that all or at least some of the dedicated banks are concurrently accessible. The number of banks dedicated to address generators might be selectable at processor startup time, or preferably be the Operating System depending on the applications currently executed, or even by the currently executed task and/or thread at runtime.

Furthermore, the amount of banks assigned to the address generators might be similarly configurable for each of the address generators.

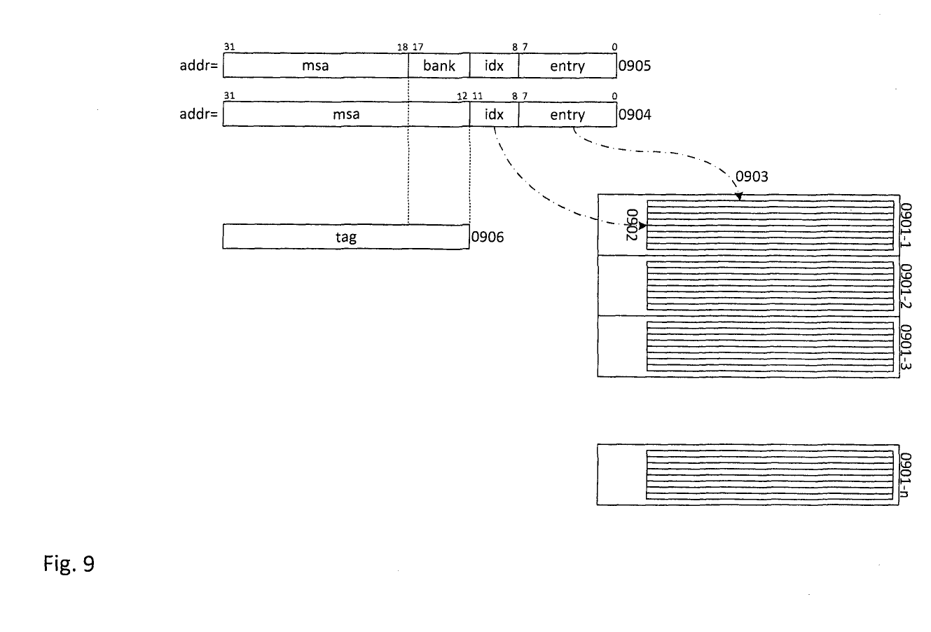

FIG. 9 shows exemplary a respective addressing model. The memory banks (0901-1, 0901-2, 0901-3, . . . , 0901-n) are preferably identically organized. In this exemplary embodiment, each bank comprises 8 lines (0902) addressable by the index (idx) part of the address (addr bits 8 to 11). Each line (0903) consists of 256 words, addressable by the entry (entry) field of the address (addr bits 0 to 7).

In this exemplary embodiment, the smallest possible Level-1 cache comprises one cache bank. The respective addressing is shown in 0904. An index range up to 10-bits shall be supported, so that address (addr) bits 8 to 17 form the largest possible logical index as shown in 0905. In this case, the bank field of the address (bank=addr bits 12 to 17) is used to select a respective memory bank (i.e. one of 0901-1, 0901-2, 0901-3, . . . , 0901-n).

Depending on the set-up the logical index (idx_{logical}) might be exactly the physical index (idx), i.e. idx_{logical}=idx. In another configuration the logical index (idx_{logical}) might be as wide as the physical index (idx) and the bank selection (bank) together, i.e. idx_{logical}={bank, idx}. In even another configuration the logical index (idx_{logical}) might be as wide as the physical index (idx) and only a part of the bank selection (bank) together, e.g. idx_{logical}={bank[1:0], idx}=addr[13:8].

Each line of each block has an associated cache TAG, as known from caches in the prior art. The TAGs are organized in banks identical to the data banks (e.g. 0901-1, 0901-2, 0901-3, . . . , 0901-n). TAG and data memory is typically almost identically addressed, with the major difference that one TAG is associated with a complete data line, so that the entry (entry) field of the address is not used for TAG memories.

A TAG of a cache line typically comprises the most significant part of the address (msa) of the data stored in that line. Also dirty and valid/empty flags are typically part of a TAG. When accessing a cache line, msa of the TAG is compared to the msa of the current address, if equal (hit) the cache line is valid for the respective data transfer, if unequal (miss), the wrong data is stored in the cache line.

Caching is well known to one skilled in the art and shall besides this brief overview not be discussed in further detail. For further details reference is made to [10], which is entirely incorporated for detailed disclosure. Particularly reference is made to [11] describing a size configurable cache architecture, which is entirely incorporated for detailed disclosure.

In the preferred embodiment of this invention, the tag field (0906) includes the bank and msa fields of the address. Including the bank field is necessary to ensure correct address match for configurations using a small logical index, e.g. idx_{logical}=idx. It is not necessary for large logical indexes, e.g. idx_{logical}={bank, idx} as bank is part of the index physically selecting the correct bank. Yet, bank is also necessary for all in-between configurations in which only a part (a less significant part) of the bank field is used for selecting a physical data bank (e.g. 0901-1, 0901-2, 0901-3, . . . , 0901-n).

Measures might be implemented to mask those bits of the bank field in the TAG which are used by the logical index. However, those measures are unnecessary in the preferred embodiments as the overlapping part of the bank field certainly matches anyhow the selected memory bank.

FIG. 10 shows an exemplary cache system according to this invention. 4 ports (port0, port1, . . . , port3) are supported by the exemplary embodiment, each connecting to an address generator. The cache system comprising 64 banks (bank0, bank1, . . . , bank63). Each bank comprises (1001) the data and TAG memory and the cache logic, e.g. hit/miss detection. At set-up, the port setup is set for each of the ports, configuring banks dedicated to each port by defining the first (first) and last (last) bank dedicated to each port. Each bank uses has its unique bank identification number (ID), e.g. 0 (zero) for bank 0 or 5 (five) for bank5. The range (first, last) configured for each port is compared (1002) to the unique bank number for each port within each bank. If the bank identification (ID) is within the defined range, it is selected for access by the respective port via a priority encoder (1003). The priority encoder might be implemented according to the following table (‘0’ is a logical zero, ‘1’ a logical one, and ‘?’ denotes a logical don't care according to Verilog syntax):

| {en3,2,1,0} | sel selecting multiplexer 1004 |
|---|---|
| 0000 | Bank unused, no port selected |
| 0001 | Select port 0 |
| 0010 | Select port 1 |
| 0100 | Select port 2 |
| 1000 | Select port 3 |
| Default | Setup error, overlap in port |
| (any other | definition: More than one port |
| combination) | configured for accessing a |
| | specific bank. Implementation |
| | specific handled, e.g. |
| | exception caused |

The multiplexer (1004) selects the respective port for accessing the cache bank.

A multiplexer bank (1011) comprises one multiplexer per port for selecting a memory bank for supplying data to the respective port. The multiplexer for each port is controlled by adding the bank field of the address to the first field of the configuration data of each respective port (1012). While the bank field selects a bank for access, the first field provides the offset for addressing the correct range of banks for each port. In this exemplary embodiment no range (validity) check is performed in this (1012) unit, as the priority encode checks already for overlapping banks and/or incorrect port setups (see table above) and may cause a trap, hardware interrupt or any other exception in case of an error.

### Modifying Bank Setup at Execution Time

Some algorithms may benefit from changing the cache configuration, particularly the bank partitioning and bank-to-address-generator assignment during execution. For example, the first setup for an algorithm does not make any specific assignment, but all banks are configured for being (exclusively) used by the main address generator. This is particularly helpful within the initialization and/or termination code of an algorithm, e.g. where data structures are sporadically and/or irregularly accessed e.g. for initialization and/or clean-up. There managing different address generators might be a burden and even increasing runtime and code size by requiring additional instructions e.g. for managing the cache banks and address generators.

While executing the core of an algorithm, the cache is then segmented by splitting its content to banks exclusively used by specific and dedicated address generators. The flexible configuration—by assigning one or a plurality of banks (first to last, see FIG. 10) to ports (i.e. address generators)—allows for flexibly reassigning any of the banks to anyone of the ports (i.e. address generators) during execution, even without the burden of flushing and filling the respective cache banks. Therefore, during the execution of an algorithm, the bank-to-port assignment can be flexibly changed at any time. Some parts of an algorithm may benefit from concurrent data access to address ranges (i.e. cache banks) different from other parts of the algorithm, so that the reassignment at runtime improves the efficiency. Particularly the flexible reassignment reduces the over-all amount of required address generators and ports, as ports can be quickly, easily and efficiently assigned to different data structures.

### Effects on Compilers and Programming Languages

Basically analysis how to partition and distribute data on the cache banks can be done by the compiler at compile time by analyzing the data access patterns and data dependencies. Reference is made to [7], particularly chapter 10, which is entirely incorporated for complete disclosure.

Such data being often concurrently accessed at the same time or within a close temporal locality are distributed to different cache banks. For example the data loaded and/or stored in Example 10.6 and depicted in FIG. 10.7 of [7].

Such data being never or comparably seldom concurrently accessed might be grouped and placed into the same cache bank.

The respective information can be retrieved e.g. from data-dependency graphs, see e.g. [7] chapter 10.3.1.

However, it might be beneficial to capacitate programmers to control the distribution of data. In the following exemplary methods are discussed for the C and/or C++ programming language. The respective methods are applicable with little or no variation on other programming languages.

With reference to the handling of data in multi-processor and/or multi-core environments as e.g. described in [2] (which is entirely embedded for full disclosure), two more aspects are discussed: One other aspect of the following methods is the support of mutex and/or semaphores (e.g. locking) mechanisms for data. Yet another aspect is defining how data is shared between the processors/cores. Reference is made to the data tags described in [2]. The methods might be used separately, one without the other, or combined in any fashion.

The most straight forward implementation in C/C++ is using aggregated data types for declaring variables merged into the same cache bank. A set of variables (e.g. int i; long x, y, z; and char c) which shall be merged into the same cache bank might be combined by the following struct:

struct bank0 {

int i;
long x, y, z;
char c;

};

The struct bank0 can be treated as one monolithic data entity by the compiler and assigned to a cache bank as a whole.

In a preferred embodiment, the cache bank can be referenced within the struct:

i)

struct A {

| | |
|---|---|
| static const int _tcmbank = 3; | // assign to cache bank 3 |

int i;
long x, y, z;
char c;

};

_tcmbank is preferably a reserved variable/keyword for referencing to a TCM and/or cache bank.

This allows adding more data to the same cache bank by another declaration, by referencing to the same _tcmbank e.g.:

struct F {

| | |
|---|---|
| static const int _tcmbank = 3; | // same cache bank 3 |

// as struct A

long w;
char d;
int j,k,l;

};

In one embodiment, the language/compiler might support a dedicated data type, e.g. _tcmbank to which a reference to a cache bank can be assigned. The reference might be an integer value or preferably an identifier (which could be a string too). For example

ii)

struct F {

| | |
|---|---|
| tcmbank bank3; | // same cache bank 3 |

// as struct A

long w;
char d;
int j,k,l;

};

In yet another embodiment, declaration might support parameters as it is e.g. known from the hardware description language Verilog. Reference is made to [12] and [13], which both are entirely embedded for full disclosure. For example:

iii)

| | |
|---|---|
| struct F #(bank3) { | // same cache bank 3 |
| | // as struct A |

long w;
char d;
int j,k,l;

};

If only a single parameter is implemented (e.g. the TCM/cache bank reference tcmbank, the above example is save. If multiple parameters are implemented, an ordered list could be used, but is known to be error-prone. Therefore the parameters are preferably defined by name as shown below:

iii2)
[2] describes an advanced caching system and memory hierarchy for multi-processor/multi-core systems. It shall be expressively noted, that the inventions are applicable on ring-bus structures, as e.g. used in Intel's SandyBridge (e.g. i5, i7) architecture.

The methods described above can be applied to implement the respective data TAGs (e.g. SO, DRO, PO, FT, SW-MR, WER, WAER, REW, KL). Respectively a reserved variable/keyword (e.g. _mttag=mult-thread tag) according to i); a data type (e.g. mttag=mult-thread tag) according to ii) or a parameter (e.g. .mttag=mult-thread tag) according to iii1) and/or iii2) can be used.

An additional tag (AUT) might be implemented, for releasing the programmer of the burden to define the tag, but to pass its definition to the compiler for automatic analysis as e.g. described in [2].

The use of the parameter method is particularly beneficial for implementing tags. It appears very burdensome being unable to use integral data types for shared variables. For example would a character declaration require a struct to define the tag:

char c;

must be written according to example ii) as

struct c {

mttype TAG; // with TAG = { e.g. SO, DRO, PO, ...}
char c;

}

Apparently the parameter format
char #(TAG) c; // with TAG={e.g. SO, DRO, PO, . . . }
   is much more convenient to write.

The tag might be implicitly defined. Preferable, whenever no tag is explicitly defined, it is set to SO (Single Owner), so that the respective integral or aggregate variable is solely dedicated to the one processor/core executing the respective thread. For details on SO reference is made to [2].

### Mutex/Locks

Respectively data might comprise implicit locks, e.g. by adding a lock variable according to the previously described methods (e.g. i), ii), iii1), iii2)). A lock variable might be implicitly inserted into aggregate data or associated to any type of data (aggregate or integral) by the compiler, whenever data is declared to be shared by a plurality of processors/cores and/or threads, e.g. as defined by the respective tag.

The integral data or aggregate data structure and the lock forms implicitly one atomic entity, with the major benefit that the programmer is largely exempt from the burden of explicitly managing locks. Simultaneous the risk of error is significantly reduced.

Preferably the lock variable holds the thread-ID. Whenever integral data or aggregate data structure is accessed the compiler inserts respective code for checking the lock. If the lock holds a nil value, the respective data is currently unused (unlocked) and can be assigned to a thread (or processor or core). Respectively the current thread's ID is written into the lock variable. Obviously reading the lock, checking its value and (if unlocked) writing the current thread ID must be an atomic data access, so that no other thread's access overlaps. For further details on mutex and locks reference is made to [2]. Further reference is made to [14] and [15], which are both fully incorporated by reference.

Storing the thread ID in the lock variable is particularly beneficial.

Usually, at some place in the code before accessing shared data, the respective lock is checked. If unlocked the lock is locked for the particular thread and the thread continues, assuming from that point in time that the data is exclusively locked for this particular thread. If locked, the thread waits until the lock becomes unlocked. This requires explicit handling by the programmer.

The inventive method is capable of automatically checking the lock whenever the respective data is accessed, as the lock is an integral part of the data (structure). However, in this case, the check would not know whether the lock—if locked—is already locked for the current thread or any other thread. Storing the thread's ID in the lock enables associating a lock with a respective thread. If the lock variable comprises the ID of the current thread it is locked for this thread and respectively the thread is free to operate on the data.

Still the locking and unlocking mechanism might be explicitly managed be the code/programmer.

On the other hand, automatic mutex/lock handling mechanism become feasible. If data is declared within a routine it will be locked within this routine and remain locked during the execution of the routine and all sub-routines called by the routine. Locking may occur in the entry code of the routine or once data is accessed. Respectively the compiler might insert locking code in the entry code of the routine. Also alternatively or preferably additionally, the compiler inserts checking and locking code whenever the respective data is accessed. Once the routine is exit to a higher level routine, the compiler will insert respective unlock-code in the routine's exit code.

In a preferred embodiment the lock variable is placed at the first position of the data (structure), which is DataStructureBaseAddress. Preferably this might be the first position (address 0 (zero)) of a TCM/cache bank.

Respectively data is addressed by ActualAddress=DataStructureBaseAddress±ElementOffset (the stack/frame pointer is omitted on purpose, but preferably DataStructureBaseAddress is relative to it).

This addressing allows the compiler to automatically insert code for managing the lock located at DataStructureBaseAddress, preferably each time before then accessing the data at DataStructureBaseAddress±ElementOffset

### Applicability on Classes

For C++(or any other object oriented programming language) the methods described above on basis of data structures (struct) can be applied on classes (e.g. class) (or the respective counterpart of an object oriented programming language), with the additional effect that the described methods might not only applied on the data but also on the code associated with a class (or defined within the class).

### Aligning Data

Data blocks being assigned to specific cache banks are preferably aligned by the compiler such that their start addresses are located on cache line boundaries of the tcm/cache banks. Accordingly the data blocks are padded at the end to fill incomplete tcm/cache bank lines.

### Managing Data TAGs

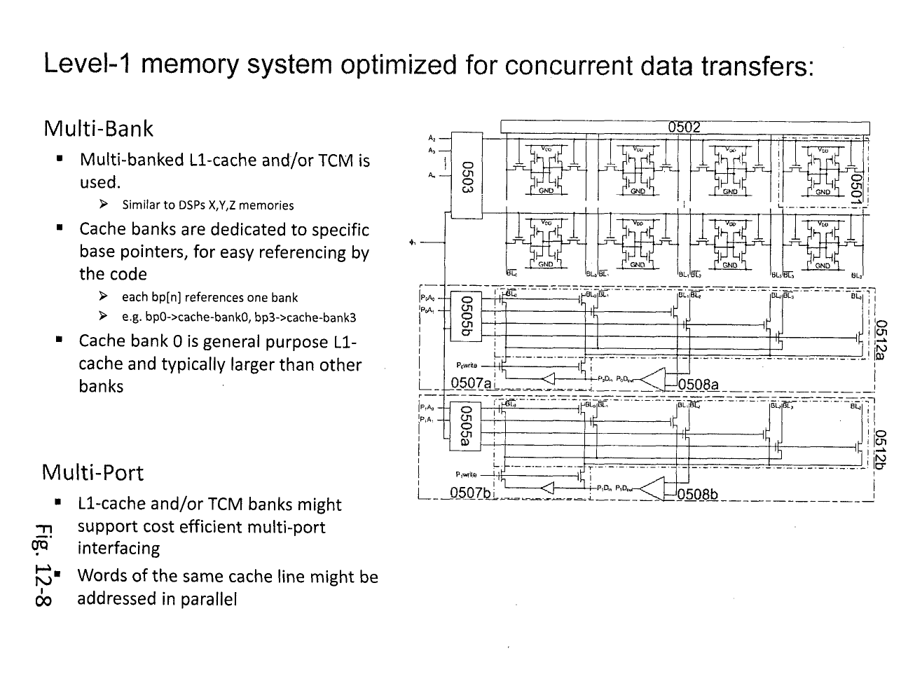

FIG. 12 shows the preferred embodiment of a data TAG management within the memory hierarchy, e.g. as described in [2].

A field identifying the tagging method (Tagging Method ID: TMID) is located in the page (1101) table for each memory page of the main memory (1102). Various kinds of tagging methods may exist, e.g.:
a) Data within this memory page is not tagged: Neither the page table nor a data header comprises a data TAG. Data has no header and is formatted and treated as data in the state of the art.
b) Data within this memory page is tagged and each data comprises explicitly a specific and/or dedicated header containing the data TAG identifying its type and/or treatment.
c) Data within this memory page is tagged, the data TAG identifying its type and/or treatment is located in the page table and common for all data. Data itself has no header and is formatted as data in the state of the art. All data in this page has implicitly the same type (as defined in the page header) and is accordingly treated the same.

Within a system and/or a thread and/or a program some or all of those methods might be mixed and simultaneously used on different data, respective different memory pages.

The processor's (1105) Memory Management Unit (MMU, 1103) evaluates the TMID and treats all data of the according page respectively. In a preferred embodiment, the TMID is copied by the MMU into the respective Translation Lookaside Buffer (TLB, 1104) comprising the according page table.

For address generation the MMU not only provides (1111) the required information for translating virtual into physical addresses for each page to the address generators of the Load/Store Units (1110), but also the assigned TMID as stored in the page table (1101) or the respective TLB (1102) entry. Accordingly, the TMID is transmitted with each address transfer to the cache hierarchy (1106). The TMID is also transferred within the cache hierarchy between the caches (1107), when one cache request data from or sends data to another cache, e.g. in data transfers between a Level-1 cache (1108) and a Level-2 cache (1109)

The caches treat the data according to the transmitted TMID. For example they may distribute and duplicate data respectively, use hardware locking and/or coherence measures for duplicated data, etc. Details are subsequently described, for more information also see [2].

Preferably the caches store the data TAG information for each cache line together with the according address TAG in their TAG memories (1112, 1113). This allows for identifying the data treatment if data is transferred or accessed autonomously between the caches. An identification of the data TAG is therefore possible by the cache's TAG memory without further requiring the information from the processor.

### Locking and Coherence in the Cache Hierarchy, e.g. a Tree And/or Ring

Reference is made to FIG. 1 of [2], subsequently referenced as FIG. 1[2], which is entirely incorporated by reference for full disclosure. FIG. 1[2] shows a memory hierarchy for multi-core and/or multi-processor arrangements, preferably on a single chip or module. The multiple node hierarchies (e.g. node level 0 comprising the nodes (0,0), (0,1), (0,2) and (0,3); node level 1, comprising the nodes (1,0) and (1,1)) are preferred for speeding up the lookup procedure, but might be omitted in some embodiments.

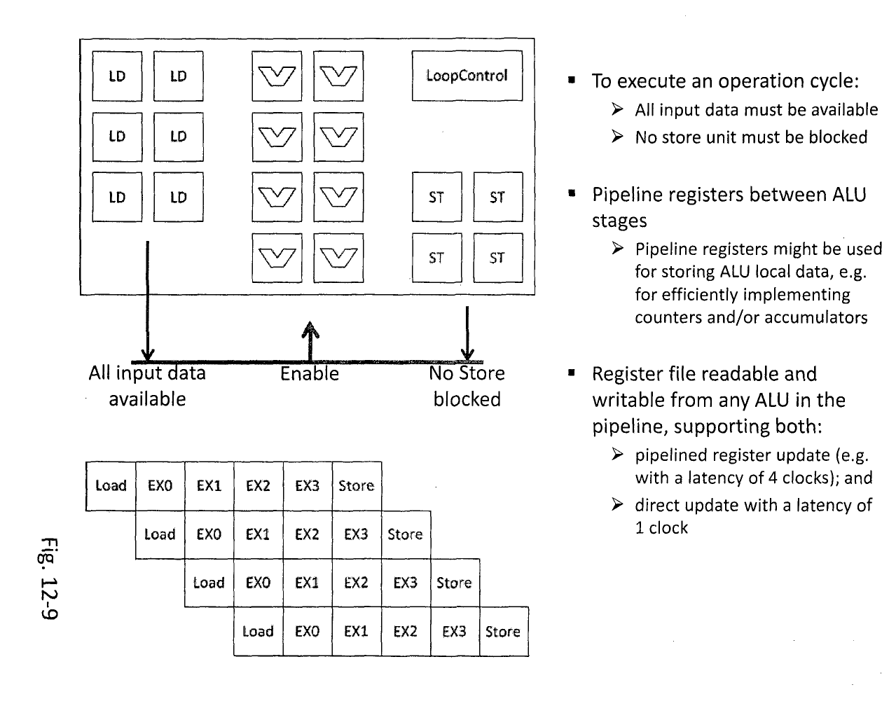

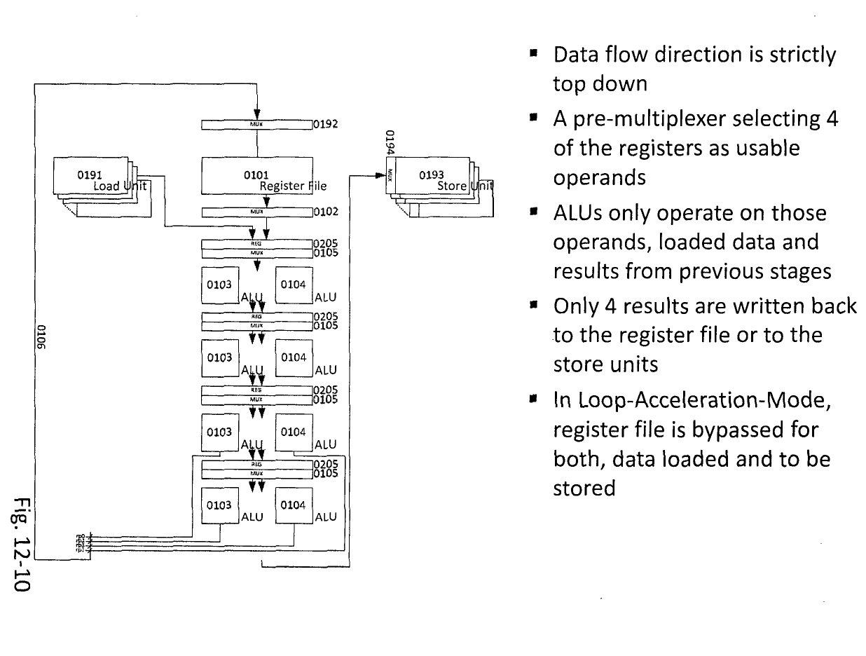

A simplified representation of FIG. 1[2] is presented as FIG. 13 of this patent. Note that the basic figure and particularly references with a trailing ‘[2]’ (e.g. such as 1599[2] or 0191[2]) are described in [2].

Preferably locks are tagged as Write-Exceeds-Read (reference is made to [2]) or with a dedicated Lock tag, so that the respective data is placed in the highest level cache memory, which is common for all cores/processors. By doing so, no coherence measures or interlocking between multiple duplicate instances of the lock in lower level caches are necessary, as only a single instance exists. The penalty of the increase latency to the highest level cache is acceptable compared to the overhead of coherence measures and interlocking.

If a lock is tagged in a way that is might be or definitively is duplicated (e.g. Write-Almost-Equal-Read, or Read-Exceeds-Write; reference is made to [2]) the memory hierarchy ensures proper management.

For example a respective lock is placed in L1 Cache 6 and a duplicate in L1 Cache 3. Core 6 requests atomic access to the lock's data. The cache management of L1 Cache 6 evaluates the data tag . . . .

### Boost-Mode

One of the fundamental issues of today's semiconductor chips is, that “with each process generation, the percentage of transistors that a chip design can switch at full frequency drops exponentially because of power constraints. A direct consequence of this is dark silicon-large swaths of a chip's silicon area that must remain mostly passive to stay within the chip's power budget. Currently, only about 1 percent of a modest-sized 32-nm mobile chip can switch at full frequency within a 3-W power budget.”; see [16].

In a preferred embodiment of the ZZYX architecture, reference is made to [1], [2], [3], [4], [5], and [6], code might alternately issue to the ALUs of the ALU-Block in single issue mode, when only a single instruction is issued per cycle, dual issue mode (two instructions issued) or Out-Of-Order mode; see [4]. Consequently, whenever the core does not operate in loop mode (superscalar mode), in which typically all ALUs are used, code might be issued to a different ALU in each code issue cycle. This has the effect that, over time, the ALUs of the ALU Block are evenly active. Assuming a datapath (ALU Block) having 8 ALUs and 2 instructions are issued per issue cycle, each ALU is only active in each fourth clock cycle. This allows the respective silicon area to cool off. Consequently the processor might be designed such, that the datapath can be overclocked in a kind of boost-mode, in which a higher clock frequency is used—at least for some time—when not all ALUs are used by the current operation mode, but alternate code issue is possible.

### Exemplary Embodiment

An exemplary embodiment of a ZZYX core is shown in FIG. 12: FIG. 12-1 shows the operation modes of an ARM based ZZYX core.

FIG. 12-2 shows an exemplary embodiment of a ZZYX core.

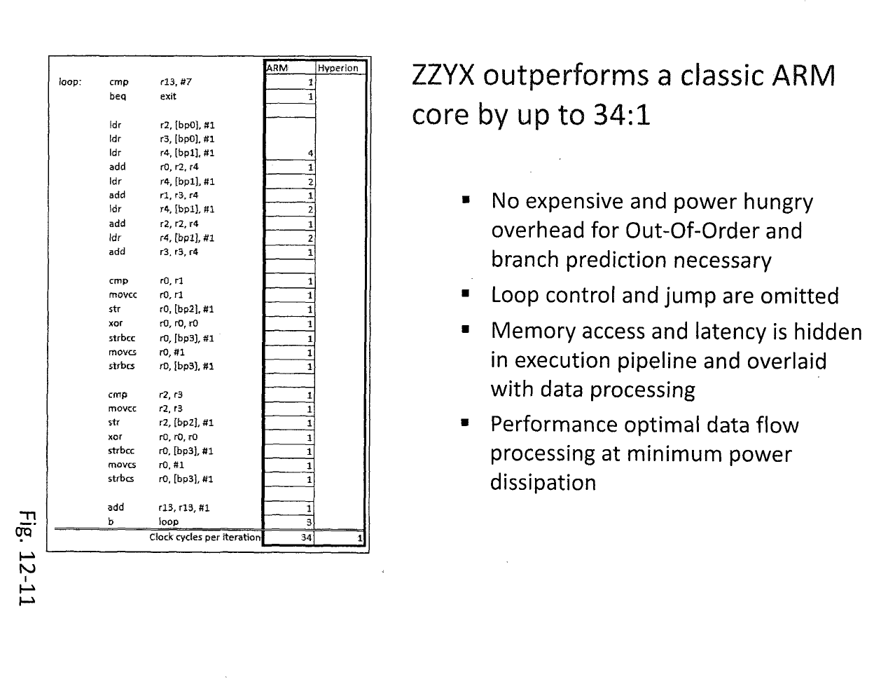

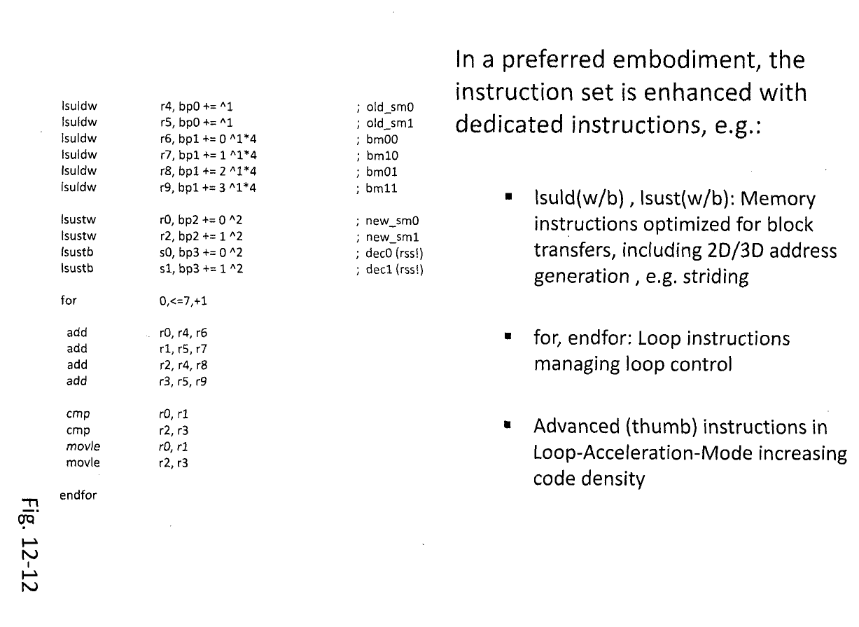

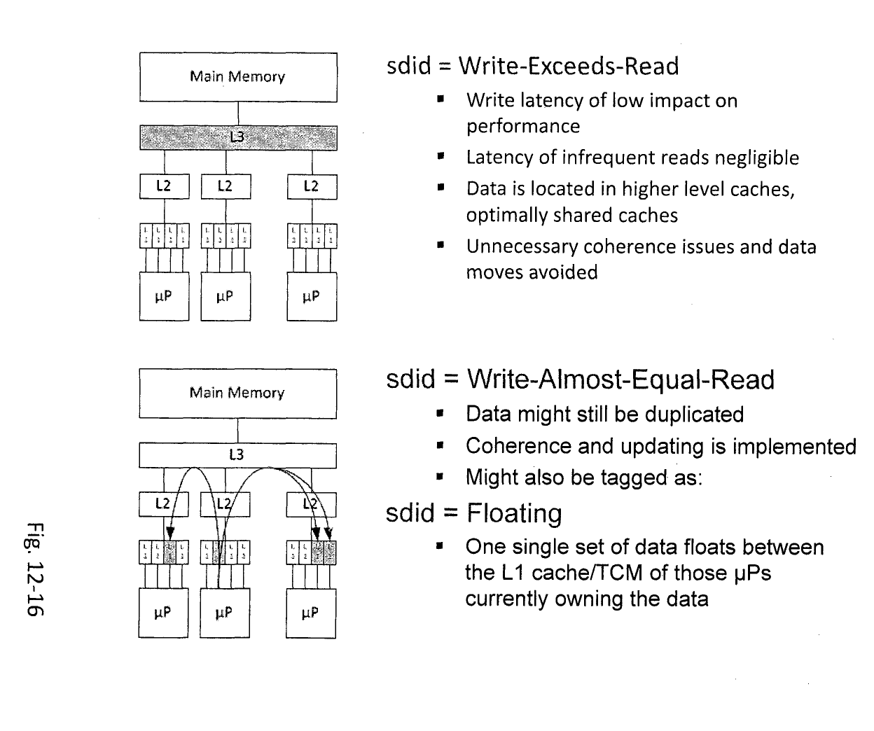

FIG. 12-3 shows an exemplary loop: The code is emitted by the compiler in a structure which is in compliance with the instruction decoder of the processor. The instruction decoder (e.g. the optimizer passes 0405 and/or 0410) recognizes code patterns and sequences; and (e.g. a rotor, see [4] FIG. 14 and/or [1] FIG. 17a and FIG. 17b) distributes the code accordingly to the function units (e.g. ALUs, control, Load/Store, etc) of the processor.

The code of the exemplary loop shown in FIGS. 12-3, 12-4, 12-5, 12-6, and 12-7 is also provided below for better readability:

| | | | |
|---|---|---|---|
| | mov | r1, r1 | ; Switch on optimization |
| | mov | r13, #0 | |
| loop: | cmp | r13, #7 | |
| | beq | exit | |
| | ldr | r2, [bp0], #1 | ; old_sm0 |
| | ldr | r3, [bp0], #1 | ; old_sm1 |
| | ldr | r4, [bp1], #1 | ; bm00 |
| | add | r0, r2, r4 | |
| | ldr | r4, [bp1], #1 | ; bm10 |
| | add | r1, r3, r4 | |
| | ldr | r4, [bp1], #1 | ; bm01 |
| | add | r2, r2, r4 | |
| | ldr | r4, [bp1], #1 | ; bm11 |
| | add | r3, r3, r4 | |
| | cmp | r0, r1 | |
| | movcc | r0, r1 | |
| | str | r0, [bp2], #1 | ; new_sm0 |
| | xor | r0, r0, r0 | ; dec0 ... |
| | strbcc | r0, [bp3], #1 | |
| | movcs | r0, #1 | |
| | strbcs | r0, [bp3], #1 | ; ... dec0 |
| | cmp | r2, r3 | |
| | movcc | r2, r3 | |
| | str | r2, [bp2], #1 | ; new_sm1 |
| | xor | r0, r0, r0 | ; dec1 ... |
| | strbcc | r0, [bp3], #1 | |
| | movcs | r0, #1 | |
| | strbcs | r0, [bp3], #1 | ; ... dec1 |
| | add | r13, r13, #1 | |
| | b | loop | |
| exit: | mov | r0, r0 | ; Switch off optimization |

The listed code has the identical structure as in the Figures for easy referencing.

The seemingly useless instructions mov r1,r1 and mov r0,r0 should be explained: In order to avoid extending the instruction set of the processor (in this example ARM) for implementing instructions switching between the data processing modes (e.g. normal operation, loop mode, etc) non-useful instructions (such as the exemplary mov instructions above) might be used for implementing the respective mode switch function. Of course nothing prevents alternatively extending the instruction set and implementing dedicated mode switch instructions respectively.

FIG. 12-4 shows the detection of the loop information (header and footer) and the respective setup of/microcode issue to the loop control unit. At the beginning of the loop the code pattern for the loop entry (e.g. header) is detected (1) and the respective instruction(s) are transferred to a loop control unit, managing loop execution. At the end of the loop the pattern of the according loop exit code (e.g. footer) is detected (1) and the respective instruction(s) are transferred to a loop control unit. For details on loop control reference is made to [1] in particular to “loop control” and “TCC”.

The detection of the code pattern might be implemented in 0405 and/or 0410. In particular microcode fusion techniques might apply for fusing the plurality of instructions of the respective code patterns into (preferably) one microcode.

FIG. 12-5 shows the setup of/microcode issue to the Load Units in accordance with detected instructions. Each instruction is issued to a different load unit and can therefore be executed independently and in particular concurrently. As the second shown instruction (ldr r3, [bp0], #1) depends on the same base pointer (bp0) as the first shown instruction (ldr r2, [bp0], #1), the address calculation of the respective two pointers must be adjusted to compute correctly within a loop when independently calculated. For example: Both pointers increment by an offset of 1. If sequentially executed, however, both addresses, address of r2 and address of r3, would move in steps of 2, as the instructions add 2-times a value of 1. But, executed in parallel and in different load units, both addresses would only move in steps of 2. Therefore the offset of both instructions must be adjusted to 2 and furthermore the base address of the second instruction (ldr r3, [bp0], #1) must be adjusted by an offset of 1. Respectively when detecting and issuing the second instruction, the offset of the first must be adjusted (as shown by the second arrow of 2). Accordingly (but not shown) must the address generation of the other load and store instructions (e.g. relative to base pointers bp1, bp2 and bp3) be adjusted.

FIG. 12-6 shows the setup of/microcode issue to the Store units in accordance with detected instruction patterns and/or macros. The store units support complex store functions storing conditionally one of a set of immediate value depending on status signals (e.g. the processor status). The shown code stores either a zero value (xor r0, r0, r0) or a one (movcs r0, #1) to the address of base pointer bp3, depending on the current status. The conditional mnemonic-extensions ‘cc’ and ‘cs’ are respectively used. For details on the ARM instruction set see [13]. As described before, the instruction decoder (e.g. the optimizer passes 0405 and/or 0410) recognizes the code patterns and sequences, which might be fused and the joint information is transmitted (1 and 2) by a microcode to the store unit.

FIG. 12-7 shows the issue of the instructions dedicated to the ALUs. The instructions are issued according to their succession in the binary code. The issue sequence is such that first a row is filled and then issuing continues with the first column of the next lower row. If an instruction to be issued depends on a previously issued instruction such, that it must be located in a lower row for being capable of receiving required results from another ALU due to network limitations, it is accordingly placed (see FIG. 12-7 6). Yet, code issue continues afterwards with the higher available ALU. Consequently issue pointer moves up again (see FIG. 12-7 7). For details on code distribution reference is made to [1] and [4] (both incorporated by reference for full disclosure), e.g. a rotor, see [4] FIG. 14 and/or [1] FIG. 17a and FIG. 17b.

FIG. 12-8 shows a Level-1 memory system supporting concurrent data access.

FIG. 12-9 shows the timing model of the exemplary ZZYX processor in loop mode: The execution is only triggered if all instructions of the respective part of the loop have been issued and the ALUs of the datapath (ALU Block) are respectively initialized, all input data, e.g. from the Load Units, is available and no output is blocked, e.g. all Store Units are ready to store new data.

FIG. 12-10 discusses the silicon area efficiency of this exemplary embodiment.

FIG. 12-11 shows the efficiency of the processor of the exemplary embodiment compared to a tradition processor while processing a code segment in loop mode.

FIG. 12-12 shows an example of an enhanced instruction set providing optimized ZZYX instructions: Shown is the same loop code, but the complex code macros requiring fusion are replaced by instructions which were added to the ARM's instruction set:

The lsuld instruction loads bytes (lsuldb) or words (lsuldw) from memory. Complex address arithmetic is supported by the instruction, in which an immediate offset is added (+=offset) to a base pointer which might then be sequentially incremented by a specific value (̂ value) with each processing cycle.

The lsust instruction stores bytes (lsustb) or words (lsustw) to memory. The address generation operates as for the lsuld instruction.

A for instruction defines loops, setting the start-, endvalues, and the step width; all in a single mnemonic. The endfor instruction respectively indicates the end of the loop code.

The code shown in FIG. 12-12 is also listed below for better readability:

| lsuldw | r4, bp0 += \hat{ }1 | ; old_sm0 |
|---|---|---|
| lsuldw | r5, bp0 += \hat{ }1 | ; old_sm1 |
| lsuldw | r6, bp1 += 0 \hat{ }1*4 | ; bm00 |
| lsuldw | r7, bp1 += 1 \hat{ }1*4 | ; bm10 |
| lsuldw | r8, bp1 += 2 \hat{ }1*4 | ; bm01 |
| lsuldw | r9, bp1 += 3 \hat{ }1*4 | ; bm11 |
| lsustw | r0, bp2 += 0 \hat{ }2 | ; new_sm0 |
| lsustw | r2, bp2 += 1 \hat{ }2 | ; new_sm1 |
| lsustb | s0, bp3 += 0 \hat{ }2 | ; dec0 (rss!) |
| lsustb | s1, bp3 += 1 \hat{ }2 | ; dec1 (rss!) |
| for | 0,<=7,+1 | |

| | |
|---|---|
| add | r0, r4, r6 |
| add | r1, r5, r7 |
| add | r2, r4, r8 |
| add | r3, r5, r9 |
| cmp | r0, r1 |
| cmp | r2, r3 |
| movle | r0, r1 |
| movle | r2, r3 |

endfor

The listed code has the identical structure as in the Figure for easy referencing.

FIG. 12-13 discusses the benefit of data tags, according to [2].

FIG. 12-14 shows an exemplary embodiment of data tags and respective exemplary C/C++ code. Note instead struct, class could be used.

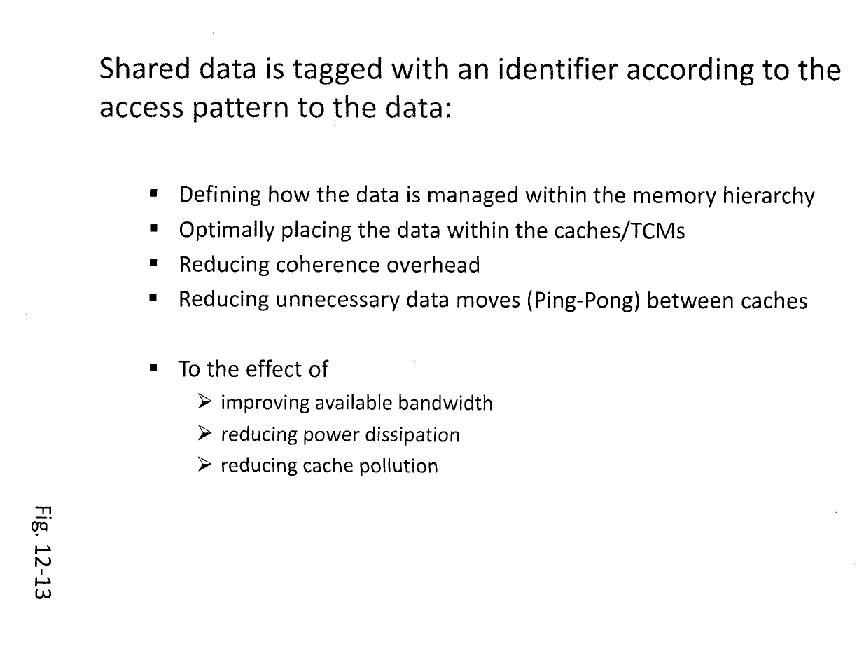

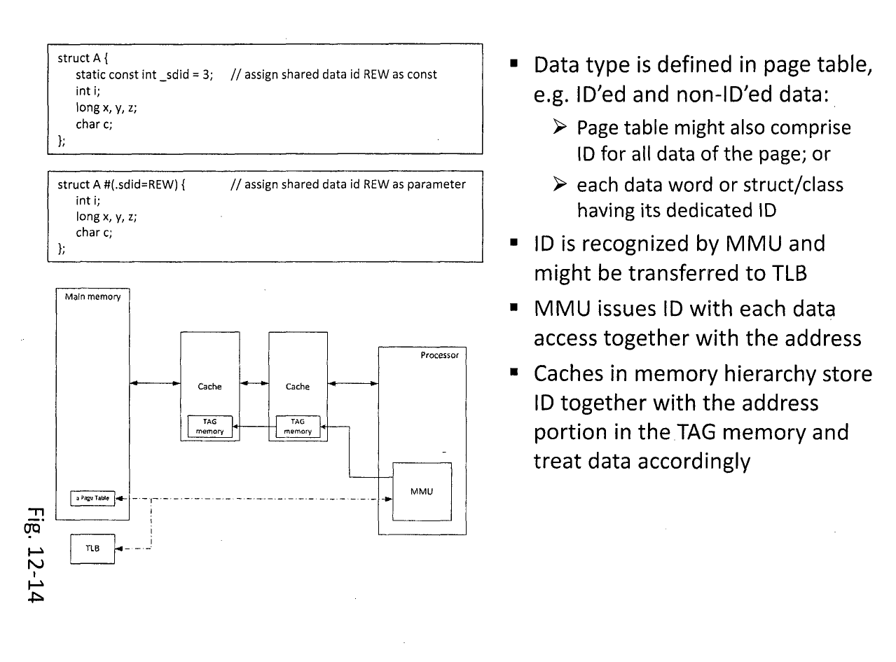

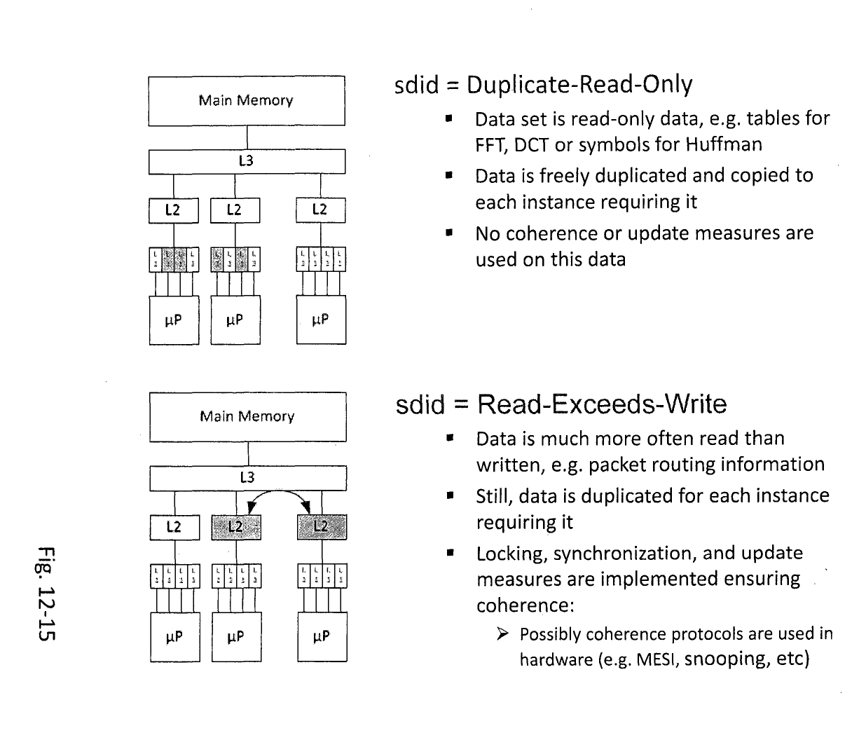

FIGS. 12-15 and 12-16 discuss exemplary data tags and their effect on data management in the memory hierarchy. For further details reference is made to [2].

### Implementation Types

The architecture described in this patent and the related patents [1], [2], [3], [4], [5], and [6] can be implemented in various ways. Amongst many, 3 variants appear particularly beneficial:

A1) The processor's instruction set is not extended with instructions controlling mode switches (to loop acceleration modes in particular). Neither is the compiler amended to generate optimized code for loop processing. The processor has internal code analyzing and optimizing units implemented (e.g. according to [4]) for detecting loops in plain standard code, analyzing and transforming them for optimized execution. Respectively this implementation might be preferred when maximum compatibility and performance of legacy code is required.

A2) The processor's instruction set is not extended with instructions controlling mode switches (to loop acceleration modes in particular). But the compiler amended to emit opcodes in an optimized pattern, so that the instructions are arranged in a way optimal for the (processor internal) issue sequence at runtime to the processor's execution units. This simplifies the processor internal loop optimization unit as the instructions do not have to be rearranged. Respectively the optimization unit is significantly smaller and less complex, requires less latency and consumes respectively less power. It shall be mentioned that this approach is also generally beneficial for processor's having a plurality of execution units, particularly when some of them have different latencies and/or processors capable of out-of-order execution. The processor still has internal code analyzing and optimizing units implemented (e.g. according to [4]) for detecting loops in plain standard code, analyzing and transforming them for optimized execution. Anyhow, the step of transforming is significantly simplified, if not completely obsolete. Respectively this implementation might be preferred when code compatibility between various processor generations is required. Generated code could still be executed on non-optimized standard processors.

B) The processor's instruction set is extended for providing additional support for loop management and/or arranging the opcodes within loops. Accordingly the compiler emits loops using the respective instructions and—as the compiler has been amended anyhow—emits loop code in an optimal instruction sequence. These measures may lead to incompatible binary code, but significantly reduce the processor's hardware complexity for loop detection and optimization and by such the silicon area and power dissipation. Respectively this implementation might be preferred for cost and/or power sensitive markets.

### LITERATURE AND PATENTS OR PATENT APPLICATIONS INCORPORATED BY REFERENCE

The following references are fully incorporated by reference into the patent for complete disclosure. It is expressively noted, that claims may comprise elements of any reference incorporated into the specification:
[1] ZZYX07: PCT/EP 2009/007415 (WO2010/043401); Vorbach
[2] ZZYX08: PCT/EP 2010/003459 (WO2010/142432); Vorbach
[3] ZZYX09: PCT/EP 2010/007950; Vorbach
[4] ZZYX10: PCT/EP 2011/003428; Vorbach
[5] ZZYX11: PCT/EP 2012/000713; Vorbach
[6] ZZYX12: DE 11 007 370.7; Vorbach
[7] Compilers: Principles, Techniques, & Tools; Second Edition (The purple dragon); Aho, Lam, Sethi, Ullman; Addison Wesley; ISBN: 0-321-48681-1
[8] Operating Systems: Design and Implementation; Tanenbaum, Woodhull; Prentice Hall/Pearson International; ISBN-13: 978-0-13-505376-8
[9] Advanced Compiler Design & Implementation; Muchnick; Morgan Kaufman Publishers; ISBN-13: 978-1-55860-320-2
[10] Cache Design for Embedded Real-Time Systems; Bruce Jacob Electrical & Computer Engineering Department; University of Maryland at College Park; blj@eng.umd.edu; http://www.ee.umd.edu/˜blj/
[11] Exploiting Choice in Resizable Cache Design to Optimize Deep-Submicron Processor Energy-Delay; Se-Hyun Yang, Michael D. Powell, Babak Falsafi, and T. N. Vijaykumar; TO APPEAR IN THE PROCEEDINGS OF THE 8TH INTERNATIONAL SYMPOSIUM ON HIGH-PERFORMANCE COMPUTER ARCHITECTURE; Computer Architecture Laboratory Carnegie Mellon University, School of Electrical and Computer Engineering Purdue University
[12] Thomas, Donald, Moorby, Phillip “The Verilog Hardware Description Language” Kluwer Academic Publishers, Norwell, Mass. ISBN 0-7923-8166-1
[13] Verilog Standard, IEEE Std 1364-2001
[14] “Modern Operating Systems”, Andrew S. Tanenbaum; ISBN-10: 0136006639; ISBN-13: 978-0136006633
[15] “Fundamentals of Computer Organization and Design, Sivarama P. Dandamudi; ISBN-10: 038795211X|ISBN-13: 978-0387952116
[16] THE GREENDROID MOBILE APPLICATION PROCESSOR: AN ARCHITECTURE FOR SILICON′S DARK FUTURE; Nathan Goulding-Hotta et al.; University of California, San Diego
[17] Architectural Exploration of the ADRES Coarse-Grained Reconfigurable Array; Bouwens et al.; IMEC, Leuven
[18] TRIPS: A polymorphous Architecture for Exploiting ILP, TLP, and DLP; K. Sankaralingam et al.; The University of Texas at Austin

1. A processor core having an execution unit comprising an arrangement of Arithmetic-Logic-Units, wherein
the operation mode of the execution unit is switchable between
a) an asynchronous operation of the Arithmetic-Logic-Units and interconnection between the Arithmetic-Logic-Units
such that a signal from the register file crosses the execution unit and is receipt by the register file in one clock cycle; and
b) a pipelined operation mode of at least one of the Arithmetic-Logic-Units and the interconnection between the Arithmetic-Logic-Units
such that a signal requires from the register file through the execution unit back to the register file more than one clock cycles.
